(19) United States
(12) Patent Application Publication
(10) Pub. No.: US 2025/0232522 A1
(43) Pub. Date: Jul. 17, 2025

(54) INTERFACE SYSTEM, CONTROL DEVICE, AND OPERATION ASSISTANCE METHOD

(71) Applicant: Mitsubishi Electric Corporation, Tokyo (JP)

(72) Inventors: Hirohiko HIGUCHI, Tokyo (JP); Maki ITO, Tokyo (JP); Shodai KAYAMA, Tokyo (JP); Hayato KIKUTA, Tokyo (JP); Natsuki TAKAGAWA, Tokyo (JP)

(73) Assignee: Mitsubishi Electric Corporation, Tokyo (JP)

(21) Appl. No.: 19/171,355

(22) Filed: Apr. 7, 2025

Related U.S. Application Data
(63) Continuation of application No. PCT/JP2022/038132, filed on Oct. 13, 2022.

(51) Int. Cl. G06T 15/20; G06T 7/20; G06T 7/70

(52) U.S. Cl. CPC G06T 15/20; G06T 7/20; G06T 7/70

(57) ABSTRACT

An interface system includes a detecting unit to detect a three-dimensional position of a detection target in a virtual space divided into a plurality of operation spaces, a position acquiring unit to acquire a three-dimensional position of the detection target detected by the detecting unit, a projecting unit to project an aerial image indicating a boundary position of each of the operation spaces in the virtual space, an operation space determining unit to determine an operation space including the three-dimensional position of the detection target on the basis of the three-dimensional position of the detection target acquired by the position acquiring unit and the boundary position of each operation space in the virtual space, and an operation information output unit to output operation information for executing a predetermined operation on a display device by using at least a determination result by the operation space determining unit.

### CROSS-REFERENCE TO RELATED APPLICATION

The present application is a continuation of International Application No. PCT/JP2022/038132, filed Oct. 13, 2022, which is incorporated herein by reference in its entirety.

### TECHNICAL FIELD

The present disclosure relates to an interface system, a control device, and an operation assistance method.

### BACKGROUND ART

Conventionally, as an operation input technology for an electronic device or the like, a technology has been proposed in which a user operates a virtual space set on a space to enable a non-contact operation input. In relation to such a technology, Patent Literature 1 discloses a display device having a function of controlling an operation input to a display screen by a user's remote operation.

This display device includes two cameras that capture a range including a user viewing a display screen, detects a second point representing a user reference position and a third point representing a position of a finger of the user with respect to a first point representing a camera reference position from videos captured by the cameras, sets a virtual plane space at a position of a predetermined length in a first direction from the second point in the space, and determines and detects a predetermined operation by the user on the basis of an entry degree of the finger of the user into the virtual plane space. Then, the display device generates operation input information on the basis of a result of the determination and detection, and controls the operation of the display device on the basis of the generated information.

Here, the virtual plane space is a space having no physical entity and is set as position coordinate values of a three-dimensional space by calculation by a processor or the like of the display device. The virtual plane space is configured as a substantially rectangular parallelepiped or flat plate-shaped space sandwiched between two virtual planes. The two virtual planes are a first virtual plane on the near side close to the user and a second virtual plane on the far side.

For example, when a point at a finger position reaches the first virtual plane from a first space before the first virtual plane and further enters a second space behind the first virtual plane, the display device automatically shifts to a state of receiving a predetermined operation and displays a cursor on the display screen. In addition, the display device determines and detects a predetermined operation (for example, touch, tap, swipe, pinch, and the like on the second virtual plane) when the point at the finger position reaches the second virtual plane through the second space and further enters a third space behind the second virtual plane. Upon detecting the predetermined operation, the display device controls the operation of the display device including display control of GUI of the display screen on the basis of the position coordinate values of the point of the detected finger position and operation information indicating the predetermined operation.

### CITATION LIST

### Patent Literatures

Patent Literature 1: JP 2021-15637 A

### SUMMARY OF INVENTION

### Technical Problem

In the display device (hereinafter also referred to as a “conventional device”) described in Patent Literature 1, a mode for receiving a predetermined operation and a mode for determining and detecting the predetermined operation are switched to each other depending on the point of the finger position of the user in the virtual plane space. However, in the above-described conventional device, it is difficult for the user to visually recognize at which position in the virtual plane space the modes are switched, in other words, it is difficult for the user to visually recognize the boundary position (the boundary position between the first space and the second space and the boundary position between the second space and the third space) of each space constituting the virtual plane space.

The present disclosure has been made to solve the above-described problems, and an object of the present disclosure is to provide a technology capable of visually recognizing boundary positions of a plurality of operation spaces constituting a virtual space to be operated by a user.

### Solution to Problem

An interface system according to the present disclosure includes processing circuitry to perform detection of a three-dimensional position of a detection target in a virtual space divided into a plurality of operation spaces, to acquire the three-dimensional position of the detection target detected by the detection, to project an aerial image indicating a boundary position of each of the plurality of operation spaces in the virtual space, to perform determination of an operation space including the three-dimensional position of the detection target on a basis of the three-dimensional position of the detection target and the boundary position of each of the plurality of operation spaces in the virtual space, and to output operation information for executing a predetermined pointer movement operation or a predetermined command execution operation to a display information of a display device, by using at least a result of the determination, wherein the predetermined pointer movement operation and the predetermined command execution operation which can be executed continuously are respectively associated with adjacent operation spaces among the plurality of operation spaces, and the aerial image is projected to a closed plane dividing the adjacent operation spaces.

### Advantageous Effects of Invention

According to the present disclosure, with the above-described configuration, it is possible to visually recognize boundary positions of a plurality of operation spaces constituting a virtual space to be operated by a user.

### BRIEF DESCRIPTION OF DRAWINGS

FIG. 1A is a perspective view illustrating a configuration example of an interface system according to a first embodiment, and FIG. 1B is a side view illustrating a configuration example of the interface system according to the first embodiment.

FIG. 2A is a perspective view illustrating a configuration example of a projecting device according to the first embodiment, and FIG. 2B is a side view illustrating the configuration example of the projecting device according to the first embodiment.

FIG. 3 is a diagram illustrating a basic operation example of the interface system according to the first embodiment.

FIG. 4 is a diagram illustrating an example of functional blocks of the interface system according to the first embodiment.

FIG. 5 is a flowchart illustrating an operation example in “A. Aerial image projection phase” of the interface system according to the first embodiment.

FIG. 6 is a flowchart illustrating an operation example in “B. Control execution phase” of the interface system according to the first embodiment.

FIG. 7 is a flowchart illustrating an operation example in “spatial processing A” of the interface system according to the first embodiment.

FIG. 8 is a flowchart illustrating an operation example in “spatial processing B” of the interface system according to the first embodiment.

FIG. 9 is a diagram describing cursor movement in the first embodiment.

FIG. 10 is a diagram describing cursor movement in the first embodiment.

FIG. 11 is a diagram describing cursor fixing in the first embodiment.

FIG. 12 is a diagram describing a left click in the first embodiment.

FIG. 13 is a diagram describing a right click in the first embodiment.

FIG. 14 is a diagram describing a left double click in the first embodiment.

FIG. 15A to FIG. 15D are diagrams for describing a pointer continuous movement operation according to the first embodiment.

FIG. 16A is a diagram describing a pointer continuous movement operation by the conventional device, and FIG. 16B is a diagram for describing a pointer continuous movement operation in the first embodiment.

FIGS. 17A and 17B are diagrams describing a scroll operation according to the first embodiment.

FIG. 18 is a flowchart illustrating another operation example in the “B. Control execution phase” of the interface system according to the first embodiment.

FIG. 19 is a flowchart illustrating an operation example in “spatial processing AB” of the interface system according to the first embodiment.

FIG. 20A is a diagram describing a left drag operation in the first embodiment, and FIG. 20B is a diagram describing a right drag operation in the first embodiment.

FIGS. 21A and 21B are diagrams illustrating a hardware configuration example of a device control device according to the first embodiment.

### DESCRIPTION OF EMBODIMENTS

Hereinafter, an embodiment will be described in detail with reference to the drawings.

### First Embodiment

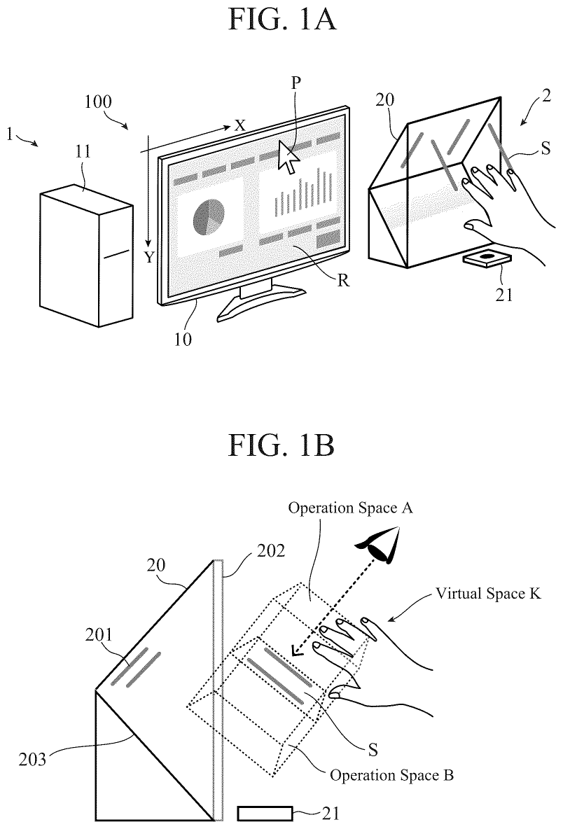

FIGS. 1A and 1B are diagrams illustrating a configuration example of an interface system 100 according to the first embodiment. For example, as illustrated in FIGS. 1A and 1B, the interface system 100 includes a display device 1 and an interface device 2. Note that FIG. 1A is a perspective view illustrating a configuration example of the interface system 100, and FIG. 1B is a side view illustrating a configuration example of the interface device 2.

### <Display Device 1>

For example, as illustrated in FIG. 1A, the display device 1 includes a display 10 and a display control device 11.

For example, under control of the display control device 11, the display 10 displays various screens including a predetermined operation screen R on which a pointer P operable by the user is displayed. The display 10 includes, for example, a liquid crystal display, a plasma display, and the like.

The display control device 11 performs control for displaying various screens on the display 10, for example. The display control device 11 includes, for example, a personal computer (PC), a server, and the like.

In the first embodiment, the user performs various operations on the display device 1 using the interface device 2 to be described later. For example, the user operates a pointer P on an operation screen displayed on the display 10 or executes various commands on the display device 1 using the interface device 2 to be described later.

### <Interface Device 2>

The interface device 2 is a non-contact device capable of inputting an operation to the display device 1 without direct contact by the user. For example, as illustrated in FIGS. 1A and 1B, the interface device 2 includes a projecting device 20 and a detecting device 21.

### <Projecting Device 20>

The projecting device 20 projects one or more aerial images S onto a virtual space K using, for example, an imaging optical system. The imaging optical system is, for example, an optical system having a light beam bending plane constituting one plane in which an optical path of light emitted from a light source is bent.

For example, as illustrated in FIG. 1B, the virtual space K is a space having no physical entity and set in a detectable range by the detecting device 21, and is a space divided into a plurality of operation spaces. Note that FIG. 1B illustrates an example in which the virtual space K is set to a posture slightly inclined with respect to the detection direction (vertical direction in FIG. 1B) by the detecting device 21, but the virtual space K is not limited thereto, and may be set to any posture.

Note that, in the following description, for clarity of the description, a case where the virtual space K is divided into two operation spaces (here, an operation space A and an operation space B) will be described as an example. At this time, in the first embodiment, the boundary position between the operation space A and the operation space B constituting the virtual space K is indicated by the aerial image S projected by the projecting device 20, for example, as illustrated in FIG. 1B.

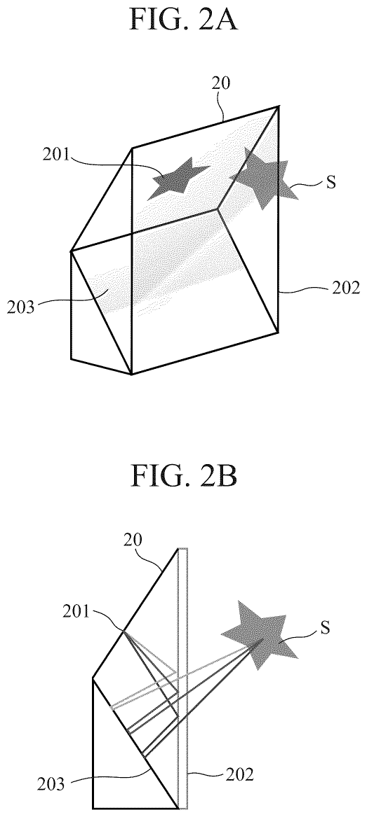

Next, a specific configuration example of the projecting device 20 will be described with reference to FIGS. 2A and 2B. FIGS. 2A and 2B illustrate an example of a case where the imaging optical system mounted on the projecting device 20 includes a beam splitter 202 and a retroreflective material 203. Note that reference numeral 201 denotes a light source. FIG. 2A is a perspective view illustrating a configuration example of the projecting device 20, and FIG. 2B is a side view illustrating the configuration example of the projecting device 20.

The light source 201 includes a display device that emits incoherent diffused light. The light source 201 includes, for example, a display device including a liquid crystal element and a backlight such as a liquid crystal display, a display device of a self-luminous device using an organic EL element and an LED element, a projecting device using a projector and a screen, or the like.

The beam splitter 202 is an optical element that separates incident light into transmitted light and reflected light, and an element surface thereof functions as the above-described light beam bending plane. The beam splitter 202 includes, for example, an acrylic plate and a glass plate. When the beam splitter 202 is formed by an acrylic plate, a glass plate, or the like, the intensity of transmitted light is generally higher than that of reflected light. Therefore, the beam splitter 202 may include a half mirror in which metal is added to an acrylic plate and a glass plate, or the like to improve reflection intensity.

In addition, the beam splitter 202 may be configured using a reflection type polarizing plate whose reflection behavior and transmission behavior change depending on a polarization state of incident light by the liquid crystal element and the thin film element. In addition, the beam splitter 202 may be configured using a reflection type polarizing plate in which a ratio between transmittance and reflectance changes in a polarization state of incident light by a liquid crystal element and a thin film element.

The retroreflective material 203 is a sheet-shaped optical element having retroreflective performance of directly reflecting incident light in an incident direction. Examples of the optical element that implements retroreflection include a bead-type optical element in which small glass beads are spread in a mirror surface shape, a minute triangular pyramid having a convex shape in which each surface is a mirror surface, and a microprism-type optical element in which a shape obtained by cutting off a central portion of the triangular pyramid is spread.

In the projecting device 20 including the imaging optical system configured as described above, for example, light (diffused light) emitted from the light source 201 is specularly reflected on the surface of the beam splitter 202, and the reflected light is incident on the retroreflective material 203. The retroreflective material 203 retroreflects the incident light and enters it into the beam splitter 202 again. The light incident on the beam splitter 202 is transmitted through the beam splitter 202 and reaches the user. Then, by following the optical path, the light emitted from the light source 201 re-converges and re-diffuses to a position plane-symmetric with the light source 201 with the beam splitter 202 as a boundary. Thus, the user can perceive the aerial image S in the virtual space K.

Note that FIGS. 2A and 2B illustrate an example in which the aerial image S is projected in a star shape, but the shape of the aerial image S is not limited thereto, and may be any shape.

Furthermore, in the above description, an example in which the imaging optical system included in the projecting device 20 includes the beam splitter 202 and the retroreflective material 203 has been described, but the configuration of the imaging optical system is not limited to the above example.

For example, the imaging optical system may include a two-surface corner reflector array element. The two-surface corner reflector array element is, for example, an element configured by arranging a plurality of two orthogonal mirror surface elements (mirrors) on a flat plate (substrate).

The two-surface corner reflector array element has a function of reflecting light incident from the light source 201 disposed on one side of the plate by one of the two mirror surface elements, and further reflecting the reflected light by the other mirror surface element to pass the light to the other side of the plate. When the light path is viewed from the side, the light entrance path and the light exit path are plane-symmetric across the plate. That is, the element surface of the two-surface corner reflector array element functions as the above-described light beam bending plane, and forms a real image by the light source 201 on one side of the plate as the aerial image S at a plane-symmetrical position on the other side.

In a case where the imaging optical system includes the two-surface corner reflector array element, the two-surface corner reflector array element is disposed at a position where the beam splitter 202 is disposed in the configuration in a case where the above-described retroreflective material 203 is used. In this case, the retroreflective material 203 is omitted.

Furthermore, the imaging optical system may include, for example, a lens array element. The lens array element is, for example, an element configured by arranging a plurality of lenses on a flat plate (substrate). In this case, the element surface of the lens array element functions as the above-described light beam bending plane, and forms a real image by the light source 201 disposed on the one side of the plate as an aerial image S at a plane-symmetrical position on the other side. In this case, the distance from the light source 201 to the element surface is substantially proportional to the distance from the element surface to the aerial image S.

Further, the imaging optical system may include, for example, a holographic element. In this case, the element surface of the holographic element functions as the above-described light beam bending plane. By projecting the light from the light source 201, which is a reference light, onto the holographic element, the holographic element outputs so as to reproduce phase information of light stored in the element. Thus, the holographic element forms a real image by the light source 201 disposed on one side of the present element as an aerial image S at a plane-symmetrical position on the other side.

### <Detecting Device 21>

The detecting device 21 detects, for example, a three-dimensional position of a detection target (for example, the hand of the user) locating in the virtual space K.

Examples of a method of detecting the detection target by the detecting device 21 include a method of irradiating the detection target with infrared rays and calculating the position in a depth direction of the detection target locating in the imaging angle of view of the detecting device 21 by detecting the time of flight (ToF) and the infrared pattern. In the first embodiment, the detecting device 21 includes, for example, a three-dimensional camera sensor or a two-dimensional camera sensor capable of detecting an infrared wavelength. In this case, the detecting device 21 can calculate the position in the depth direction of the detection target locating in the imaging angle of view, and can detect the three-dimensional position of the detection target.

In addition, the detecting device 21 may be configured by a device that detects a position in a one-dimensional depth direction, such as a line sensor. Note that, in a case where the detecting device 21 includes a line sensor, it is possible to detect the three-dimensional position of the detection target by arranging a plurality of line sensors depending on the detection range.

Furthermore, for example, the detecting device 21 may include a stereo camera device including a plurality of cameras. In this case, the detecting device 21 performs triangulation from the feature point detected in the imaging angle of view, and detects the three-dimensional position of the detection target.

### <Virtual Space K>

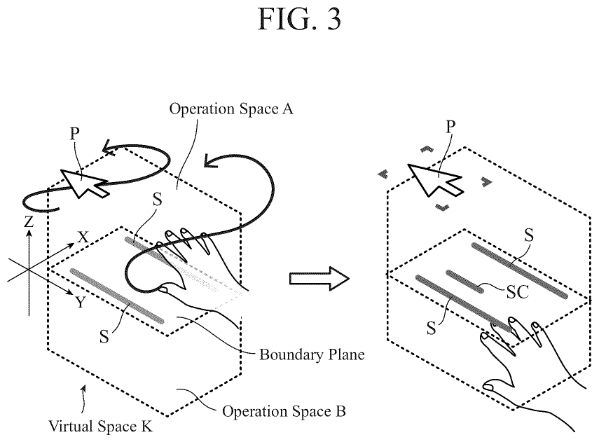

Next, a specific configuration example of the virtual space K will be described with reference to FIG. 3.

As described above, the virtual space K is a space having no physical entity set in the detectable range by the detecting device 21, and is a space divided into the operation space A and the operation space B. For example, as illustrated in FIG. 3, the virtual space K is a space which is set in a rectangular parallelepiped shape as a whole and is divided into two operation spaces (an operation space A and an operation space B). In the following description, the operation space A is also referred to as a “first operation space”, and the operation space B is also referred to as a “second operation space”.

In this case, the aerial image S projected onto the virtual space K by the projecting device 20 indicates a boundary position between the operation space A and the operation space B which are two operation spaces. In FIG. 3, two aerial images S are projected. These aerial images S are projected on a closed plane (hereinafter, this plane is also particularly referred to as a “boundary plane”) dividing the operation space A and the operation space B. Note that although FIG. 3 illustrates an example in which two aerial images S are projected, the number of aerial images S is not limited thereto, and may be, for example, one or three or more. In addition, here, for clarity of the description, as illustrated in FIG. 3, a lateral direction of the boundary plane is defined as an X-axis direction, a longitudinal direction thereof is defined as a Y-axis direction, and a direction orthogonal to the X-axis direction and the Y-axis direction is defined as a Z-axis direction.

In addition, in the operation space A and the operation space B, an operation that can be executed by the user in a case where the three-dimensional position of the detection target detected by the detecting device 21 is included is associated with each operation space. Note that, in the following description, for clarity of the description, a case where the detection target by the detecting device 21 is a hand of the user will be described as an example. In this case, the detecting device 21 detects the three-dimensional position of the hand of the user in the virtual space K, in particular, the three-dimensional position of the five fingers of the hand of the user in the virtual space K.

For example, the operation space A is associated with an operation of the pointer P as an executable operation by the user. Specifically, for example, in a case where the user puts the hand into the operation space A, that is, in a case where the three-dimensional positions of the five fingers of the hand of the user detected by the detecting device 21 are all included in the operation space A, when the user moves the hand in the operation space A, the user can move the pointer P displayed on the operation screen R of the display 10 in conjunction with the movement (left side in FIG. 3). Note that, although the pointer P is represented on the operation space A as a conceptual diagram on the left side of FIG. 3, the pointer P displayed on the operation screen R of the display 10 actually moves.

Note that, in the following description, “the three-dimensional position of the hand of the user is included in the operation space A“means that” the three-dimensional positions of the five fingers of the hand of the user are all included in the operation space A”. Furthermore, in the following description, “the user operates the operation space A” means “the user moves the hand in a state where the three-dimensional position of the hand of the user is included in the operation space A”. Furthermore, in the following description, the operation mode of the interface system 100 in a case where the user puts the hand into the operation space A is also referred to as a “pointer operation mode”.

Furthermore, in a case where the user puts the hand from the operation space A into the operation space B across the boundary position (boundary plane), that is, in a case where the three-dimensional positions of the five fingers of the hand of the user detected by the detecting device 21 are all included in the operation space B, a motion of the pointer P displayed on the operation screen R is fixed on the display 10 (right side in FIG. 3). Note that, on the right side of FIG. 3, fixing of the motion of the pointer P is indicated by square brackets displayed at the four corners of the pointer P.

At this time, even if the user moves the hand in the operation space B, the pointer P does not move. On the other hand, when the user moves the hand in a predetermined pattern in the operation space B, the user can execute a command (left click, right click, or the like) corresponding to this motion (gesture).

Note that, in the following description, “the three-dimensional position of the hand of the user is included in the operation space B“means that” the three-dimensional positions of the five fingers of the hand of the user are all included in the operation space B”. Further, in the following description, “the user operates the operation space B” means “The user moves the hand in a state where the three-dimensional position of the hand of the user is included in the operation space B”. Furthermore, in the following description, an operation mode of the interface system 100 in a case where the user puts the hand into the operation space B is also referred to as a “command execution mode”.

Note that the range of the operation space A is, for example, a range from the position of the boundary plane on which the aerial image S is projected to the upper limit position of the detectable range by the detecting device 21 in the Z-axis direction in FIG. 3. Further, the range of the operation space B is, for example, a range from the position of the boundary plane on which the aerial image S is projected to the lower limit position of the detectable range by the detecting device 21 in the Z-axis direction in FIG. 3.

Note that, on the right side of FIG. 3, an aerial image SC is an aerial image projected by the projecting device 20 when the user puts the hand from the operation space A into the operation space B across the boundary position (boundary plane). The aerial image SC is an aerial image indicating a lower limit position of a detectable range by the detecting device 21 and indicating a reference position for dividing the operation space B into right and left spaces as viewed from the user side. The aerial image SC is projected by the projecting device 20 near the lower limit position of the detectable range by the detecting device 21 and near the substantially center of the operation space B in the X-axis direction. The aerial image S is located on a plane (boundary plane) whose coordinate position in the Z-axis direction is 0, whereas the aerial image SC is located in a region whose coordinate position in the Z-axis direction is negative. Thus, the user can easily grasp how much the hand may be lowered in the operation space B, and can execute a command that requires left and right designation such as left click and right click. A method of inputting commands such as the left click and the right click will be described later.

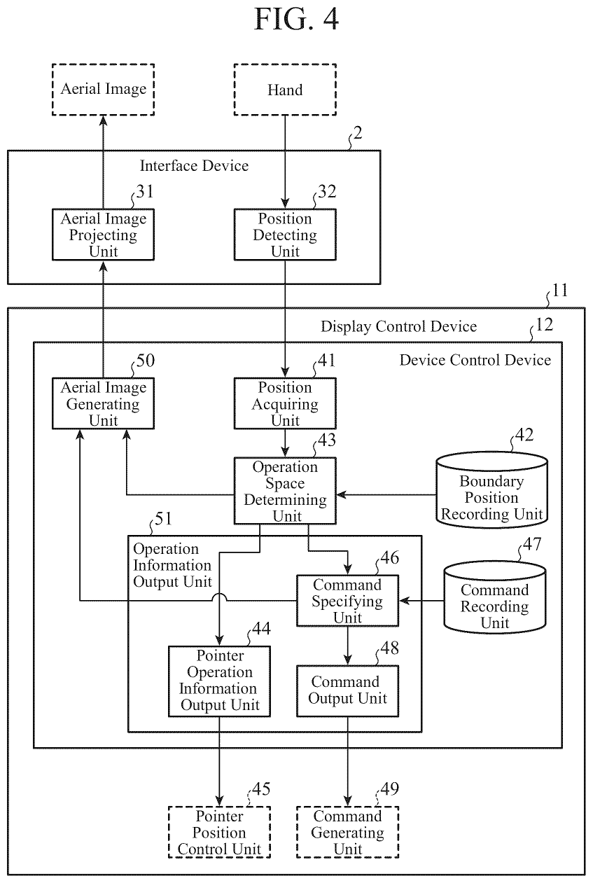

Next, functional blocks of the interface system 100 according to the first embodiment will be described. FIG. 4 illustrates an example of a functional block diagram of the interface system 100 according to the first embodiment.

As illustrated in FIG. 4, the interface system 100 includes an aerial image projecting unit 31, a position detecting unit 32, a position acquiring unit 41, a boundary position recording unit 42, an operation space determining unit 43, a pointer operation information output unit 44, a pointer position control unit 45, a command specifying unit 46, a command recording unit 47, a command output unit 48, a command generating unit 49, and an aerial image generating unit 50.

The aerial image projecting unit 31 acquires data representing the aerial image S generated by the aerial image generating unit 50, and projects the aerial image S based on the acquired data on the virtual space K. The aerial image projecting unit 31 includes, for example, the above-described projecting device 20. Note that the aerial image projecting unit 31 may acquire data indicating the above-described aerial image SC generated by the aerial image generating unit 50 and project the aerial image SC based on the acquired data on the virtual space K.

The position detecting unit 32 detects the three-dimensional position of the detection target (here, the hand of the user) in the virtual space K. The position detecting unit 32 includes, for example, the above-described detecting device 21. The position detecting unit 32 outputs a detection result (hereinafter also referred to as a “position detection result”) of the three-dimensional position of the detection target to the position acquiring unit 41.

Furthermore, the position detecting unit 32 may detect the three-dimensional position of the aerial image S projected onto the virtual space K, and record data indicating the detected three-dimensional position of the aerial image S in the boundary position recording unit 42.

Note that, in a case where the aerial image projecting unit 31 includes the above-described projecting device 20 and the position detecting unit 32 includes the detecting device 21, the functions of the aerial image projecting unit 31 and the position detecting unit 32 are implemented by the above-described interface device 2.

The position acquiring unit 41 acquires the position detection result output from the position detecting unit 32. The position acquiring unit 41 outputs the acquired position detection result to the operation space determining unit 43.

The boundary position recording unit 42 records data indicating the boundary position between the operation space A and the operation space B constituting the virtual space K, that is, the three-dimensional position of the aerial image S. The boundary position recording unit 42 includes, for example, a hard disc drive (HDD), a solid state drive (SSD), or the like.

For example, in a case where the aerial image S is constituted by a line (straight line) graphic as illustrated in FIG. 3, the boundary position recording unit 42 records data indicating a three-dimensional position of at least one point among points (pixels) of the aerial image S constituting the line. For example, the boundary position recording unit 42 may record data indicating the three-dimensional positions of any three points among the points of the aerial image S constituting the line, or may record data indicating the three-dimensional positions of all the points among the points of the aerial image S constituting the line. Note that since the aerial image S is projected on the boundary plane illustrated in FIG. 3, coordinate positions of points recorded in the boundary position recording unit 42 in the Z-axis direction are the same coordinate position.

The operation space determining unit 43 acquires the position detection result output from the position acquiring unit 41. Furthermore, the operation space determining unit 43 determines the operation space in which the hand of the user is located on the basis of the acquired position detection result and the boundary position of each operation space in the virtual space K. The operation space determining unit 43 outputs a determination result (hereinafter also referred to as a “space determination result”) to the aerial image generating unit 50. In addition, the operation space determining unit 43 outputs the space determination result to an operation information output unit 51 together with the position detection result acquired from the position acquiring unit 41.

The operation information output unit 51 outputs operation information for executing a predetermined operation on the display device 1 using at least a space determination result by the operation space determining unit 43. The operation information output unit 51 includes the pointer operation information output unit 44, the command specifying unit 46, and the command output unit 48.

The pointer operation information output unit 44 acquires the space determination result and the position detection result output from the operation space determining unit 43. In a case where the acquired space determination result indicates that the hand of the user is located in the operation space A, the pointer operation information output unit 44 generates information (hereinafter also referred to as “movement control information”) for moving the pointer P displayed on the operation screen R of the display 10 in accordance with the motion of the hand of the user in the operation space A. Note that the “movement of the hand of the user” includes information regarding a motion such as a motion amount of the hand of the user. For example, the pointer operation information output unit 44 calculates the motion amount of the hand of the user on the basis of the position detection result output from the operation space determining unit 43. The motion amount of the hand of the user includes information regarding a direction in which the hand of the user moves and a distance in which the hand of the user moves in the direction.

Then, the pointer operation information output unit 44 generates information (movement control information) for moving the pointer P displayed on the operation screen R of the display 10 in accordance with the motion of the hand of the user in the operation space A on the basis of the calculated motion amount. The pointer operation information output unit 44 outputs the operation information including the generated movement control information to the pointer position control unit 45.

Furthermore, in a case where the acquired space determination result indicates that the hand of the user is located in the operation space B, the pointer operation information output unit 44 generates information (hereinafter also referred to as “fixing control information”) indicating that the pointer P displayed on the operation screen R of the display 10 is fixed. The pointer operation information output unit 44 outputs the operation information including the generated fixing control information to the pointer position control unit 45.

Note that the pointer operation information output unit 44 may include information indicating that a moving amount or a moving speed of the pointer P displayed on the screen of the display device 1 is variable depending on the distance between the three-dimensional position of the hand of the user included in the operation space A and the boundary plane of the virtual space K represented by the aerial image S, that is, the distance in the direction orthogonal to the boundary plane (Z-axis direction in FIG. 3), and output the operation information.

The pointer position control unit 45 acquires the operation information output from the pointer operation information output unit 44. In a case where the movement control information is included in the operation information acquired from the pointer operation information output unit 44, the pointer position control unit 45 moves the pointer P on the operation screen R displayed on the display 10 in accordance with the motion of the hand of the user on the basis of the movement control information. For example, the pointer position control unit 45 moves by an amount corresponding to the motion amount of the hand of the user, in other words, in a direction included in the motion amount, by a distance included in the motion amount.

Further, when the operation information acquired from the pointer operation information output unit 44 includes the fixing control information, the pointer position control unit 45 fixes the pointer P on the operation screen R displayed on the display 10 on the basis of the fixing control information.

The command specifying unit 46 acquires the space determination result and the position detection result output from the operation space determining unit 43. In a case where the acquired space determination result indicates that the hand of the user is located in the operation space B, the command specifying unit 46 specifies the motion (gesture) of the hand of the user on the basis of the position detection result output from the operation space determining unit 43.

The command recording unit 47 records command information in advance. The command information is information in which a motion (gesture) of a hand of the user is associated with a command that can be executed by the user. The command recording unit 47 includes, for example, a hard disc drive (HDD), a solid state drive (SSD), or the like.

The command specifying unit 46 specifies a command corresponding to the specified hand motion (gesture) of the user on the basis of the command information recorded in the command recording unit 47. The command specifying unit 46 outputs the specified command to the command output unit 48 and the aerial image generating unit 50.

The command output unit 48 acquires the command output from command specifying unit 46. The command output unit 48 outputs the operation information including information indicating the acquired command to the command generating unit 49.

The command generating unit 49 receives the operation information output from the command output unit 48 and generates a command included in the received operation information. Thus, in the interface system 100, a command corresponding to the motion (gesture) of the hand of the user is executed.

The aerial image generating unit 50 generates data representing the aerial image S projected onto the virtual space K by the aerial image projecting unit 31. The aerial image generating unit 50 outputs data indicating the generated aerial image S to the aerial image projecting unit 31.

Further, the aerial image generating unit 50 may acquire the space determination result output from the operation space determining unit 43 and regenerate data representing the aerial image S projected in a mode depending on the acquired space determination result. Furthermore, the aerial image generating unit 50 may output data indicating the regenerated aerial image S to the aerial image projecting unit 31.

For example, in a case where the space determination result indicates that the hand of the user is located in the operation space A, the aerial image generating unit 50 may regenerate data representing the aerial image S projected in blue. Further, in a case where the space determination result indicates that the hand of the user is located in the operation space B, the aerial image generating unit 50 may regenerate data representing the aerial image S projected in red. Furthermore, in a case where the space determination result indicates that the hand of the user is located in the operation space B, the aerial image generating unit 50 may generate data representing the aerial image SC described above and output the data indicating the generated aerial image SC to the aerial image projecting unit 31.

Further, the aerial image generating unit 50 may acquire the command output from the command specifying unit 46 and regenerate data representing the aerial image S projected in a mode according to the acquired command. Furthermore, the aerial image generating unit 50 may output data indicating the regenerated aerial image S to the aerial image projecting unit 31.

For example, when the command acquired from the command specifying unit 46 is the left click, the aerial image generating unit 50 may regenerate data representing the aerial image S that blinks once. In addition, when the command acquired from the command specifying unit 46 is the left double click, the aerial image generating unit 50 may regenerate data representing the aerial image S that blinks continuously twice.

Note that the operation information output unit 51 described above may include a sound information output unit (not illustrated) that generates information indicating to output a sound corresponding to the fixation of the pointer P (a sound for notifying the fixation of the pointer P) when the operation information including the fixing control information is output from the pointer operation information output unit 44 to the pointer position control unit 45, and outputs the generated information by including the generated information in the operation information. In this case, when the pointer position control unit 45 fixes the pointer P on the basis of the fixing control information, a sound corresponding to the fixing of the pointer P is output. Therefore, the user can easily grasp that the pointer P is fixed by listening to this sound.

Furthermore, the sound information output unit may generate information indicating to output a sound corresponding to the command specified by the command specifying unit 46, and may output the generated information by including in the generated information in the operation information. In this case, when the command generating unit 49 generates a command, a sound corresponding to the command is output. Therefore, the user can easily grasp that the command has generated by listening to this sound.

Further, the sound information output unit may generate information indicating to output a sound corresponding to the three-dimensional position of the hand of the user in the operation space A or a sound corresponding to the motion of the hand of the user in the operation space A, and may output the generated information by including the generated information in the operation information. For example, the sound information output unit may generate information indicating to output a sound corresponding to the three-dimensional position on the basis of the three-dimensional position of the hand of the user in the operation space A detected by the position detecting unit 32, include the generated information in the operation information, and output the operation information. In this case, for example, when the user brings the hand close to the boundary plane in the operation space A, a sound in which the volume increases as the hand of the user approaches the boundary plane is output. By listening to this sound, the user can easily grasp that the hand has approached the boundary plane.

Furthermore, for example, the sound information output unit may generate information indicating to output a sound corresponding to the motion amount on the basis of the motion amount of the hand of the user calculated by the pointer operation information output unit 44, include the generated information in the operation information, and output the operation information. In this case, for example, as the user moves the hand more in the operation space A (as the moving amount of the hand is larger), a sound with a larger volume is output. By listening to this sound, the user can easily grasp that the hand has moved greatly. In this manner, the user can easily grasp the three-dimensional position of the hand or the motion of the hand in the operation space A by listening to the sound.

Note that, in the first embodiment, the position acquiring unit 41, the boundary position recording unit 42, the operation space determining unit 43, the pointer operation information output unit 44, the pointer position control unit 45, the command specifying unit 46, the command recording unit 47, the command output unit 48, the command generating unit 49, and the aerial image generating unit 50 described above are mounted on, for example, the display control device 11 described above. Furthermore, in this case, a device control device 12 includes the position acquiring unit 41, the boundary position recording unit 42, the operation space determining unit 43, the pointer operation information output unit 44, the command specifying unit 46, the command recording unit 47, the command output unit 48, and the aerial image generating unit 50. The device control device 12 controls the interface device 2.

Note that, although the example in which the boundary position recording unit 42 and the command recording unit 47 are mounted on the device control device 12 has been described in the above description, the boundary position recording unit 42 and the command recording unit 47 are not limited thereto, and may be provided outside the device control device 12.

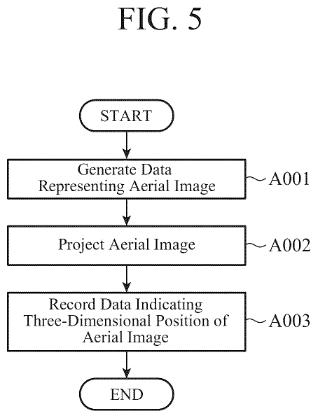

Next, an operation example of the interface system 100 according to the first embodiment will be described with reference to flowcharts illustrated in FIGS. 5 to 8. Here, for clarity of the description, an operation example of the interface system 100 will be described separately for “A. Aerial image projection phase” and “B. Control execution phase”.

### <A. Aerial Image Projection Phase>

First, the aerial image projection phase will be described with reference to a flowchart illustrated in FIG. 5. In the aerial image projection phase, the aerial image S is projected in the virtual space K. Note that the aerial image projection phase is executed at least once when the interface system 100 is activated.

First, the aerial image generating unit 50 generates data representing the aerial image S to be projected by the aerial image projecting unit 31 onto the virtual space K (step A001). The aerial image generating unit 50 outputs data indicating the generated aerial image S to the aerial image projecting unit 31.

Next, the aerial image projecting unit 31 acquires data representing the aerial image S generated by the aerial image generating unit 50, and projects the aerial image S based on the acquired data on the virtual space K (step A002).

Next, the position detecting unit 32 detects the three-dimensional position of the aerial image S projected onto the virtual space K, and records data indicating the detected three-dimensional position of the aerial image S in the boundary position recording unit 42 (step A003).

Note that, in the above description, an example has been described in which the aerial image projecting unit 31 first projects the aerial image S, the position detecting unit 32 then detects the three-dimensional position of the aerial image S, and the data indicating the detected three-dimensional position of the aerial image S is recorded in the boundary position recording unit 42. However, step A003 is not an essential process and may be omitted. For example, in the interface system 100, the user may first record data indicating the three-dimensional position of the aerial image S in the boundary position recording unit 42, and the aerial image projecting unit 31 may project the aerial image S at the three-dimensional position indicated by the data, and in this case, step A003 may be omitted.

### <B. Control Execution Phase>

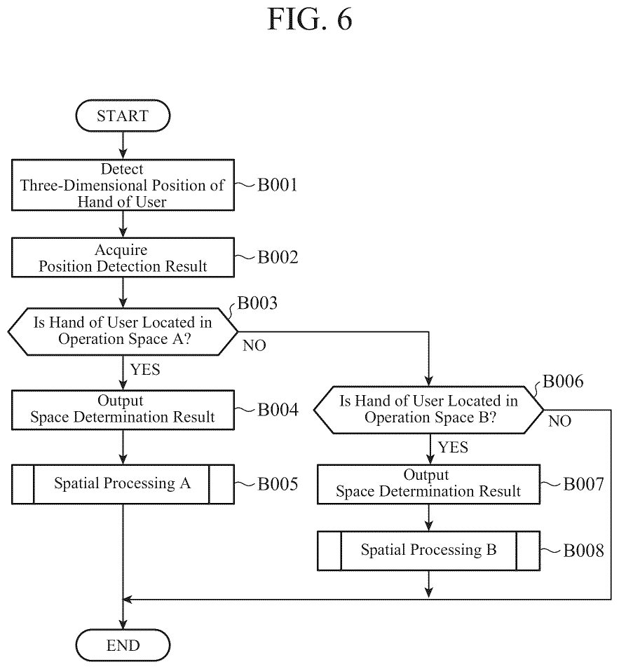

Next, the control execution phase will be described with reference to a flowchart illustrated in FIG. 6. In the control execution phase, the user uses the interface device 2, and control by the display control device 11 and the device control device 12 is executed. Note that the control execution phase is repeatedly executed at predetermined intervals after the above-described aerial image projection phase is completed.

First, when the user enters a hand into the virtual space K, the position detecting unit 32 detects the three-dimensional position of the hand of the user in the virtual space K (step B001). The position detecting unit 32 outputs a detection result (position detection result) of the three-dimensional position of the hand of the user to the position acquiring unit 41.

Next, the position acquiring unit 41 acquires the position detection result output from the position detecting unit 32 (step B002). The position acquiring unit 41 outputs the acquired position detection result to the operation space determining unit 43.

Next, the operation space determining unit 43 acquires the detection result output from the position acquiring unit 41, and determines the operation space in which the hand of the user is located on the basis of the acquired position detection result and the boundary position of each operation space in the virtual space K.

For example, the operation space determining unit 43 compares the position coordinate values of the five fingers of the hand of the user in the Z-axis direction illustrated in FIG. 3 with the position coordinate values of the boundary position between the operation space A and the operation space B in the Z-axis direction. Then, the operation space determining unit 43 determines that the hand of the user is located in the operation space A when the former is equal to the latter or the former is above the latter (+Z direction). On the other hand, if the former is lower than the latter (−Z direction), the operation space determining unit 43 determines that the hand of the user is located in the operation space B.

Next, the operation space determining unit 43 checks whether or not it is determined that the hand of the user is located in the operation space A (step B003). When it is determined that the hand of the user is located in the operation space A (step B003; YES), the operation space determining unit 43 outputs the determination result (space determination result) to the aerial image generating unit 50 (step B004). Further, the operation space determining unit 43 outputs the space determination result to the pointer operation information output unit 44 together with the position detection result acquired from the position acquiring unit 41 (step B004). Thereafter, the processing proceeds to step B005 (spatial processing A).

On the other hand, when it is determined in step B003 that the hand of the user is not located in the operation space A (step B003; NO), the operation space determining unit 43 checks whether or not it is determined that the hand of the user is located in the operation space B (step B006). When it is determined that the hand of the user is located in the operation space B (step B006; YES), the operation space determining unit 43 outputs the determination result (space determination result) to the aerial image generating unit 50 (step B007). In addition, the operation space determining unit 43 outputs the space determination result to the pointer operation information output unit 44 and the command specifying unit 46 together with the position detection result acquired from the position acquiring unit 41 (step B007). Thereafter, the processing proceeds to step B008 (spatial processing B).

On the other hand, in a case where it is determined in step B006 that the hand of the user is not located in the operation space B (step B006; NO), the interface system 100 ends the process.

### <Spatial Processing A>

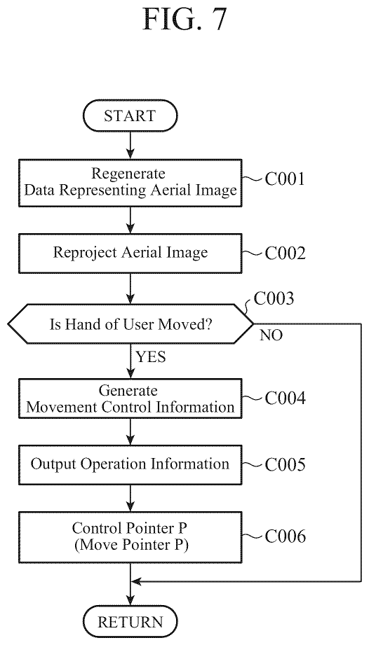

Next, spatial processing A in step B005 will be described with reference to a flowchart illustrated in FIG. 7.

First, the aerial image generating unit 50 acquires the space determination result indicating that the hand of the user is located in the operation space A, which is output from the operation space determining unit 43, and regenerates data representing the aerial image S projected in a mode depending on the acquired space determination result (step C001). For example, the aerial image generating unit 50 regenerates data representing the aerial image S projected in blue as the aerial image S indicating that the hand of the user is located in the operation space A. The aerial image generating unit 50 outputs data indicating the regenerated aerial image S to the aerial image projecting unit 31.

Next, the aerial image projecting unit 31 acquires data representing the aerial image S regenerated by the aerial image generating unit 50, and reprojects the aerial image S based on the acquired data onto the virtual space K (step C002). That is, the aerial image projecting unit 31 updates the aerial image S projected on the virtual space K. Thus, for example, the color of the aerial image S changes to blue, and the user can easily grasp that the hand has entered the operation space A (that the pointer operation mode has been set). Note that step C001 and step C002 are not essential processes and may be omitted.

Next, the pointer operation information output unit 44 determines whether or not there has been a motion of the hand of the user on the basis of the position detection result output from the operation space determining unit 43 (step C003). As a result, when it is determined that there has been no motion of the hand of the user (step C003; NO), the processing returns. On the other hand, in a case where it is determined that there has been a motion of the hand of the user (step C003; YES), the processing proceeds to step C004.

In step C004, the pointer operation information output unit 44 specifies the motion of the hand of the user on the basis of the position detection result output from the operation space determining unit 43. Then, the pointer operation information output unit 44 generates information (movement control information) for moving the pointer P displayed on the operation screen R of the display 10 in accordance with the motion of the hand of the user in the operation space A (step C004). In addition, the pointer operation information output unit 44 outputs operation information including the generated movement control information to the pointer position control unit 45 (step C005).

Next, the pointer position control unit 45 controls the pointer P on the basis of the movement control information included in the operation information output from the pointer operation information output unit 44 (step C006). Specifically, the pointer position control unit 45 moves the pointer P on the operation screen R displayed on the display 10 in accordance with the motion of the hand of the user on the basis of the movement control information. More specifically, the pointer position control unit 45 moves the pointer P on the operation screen R displayed on the display 10 by an amount corresponding to the motion amount of the hand of the user, in other words, by a distance included in the motion amount in a direction included in the motion amount. Thus, the pointer P moves in conjunction with the motion of the hand of the user. Thereafter, the processing returns.

### <Spatial Processing B>

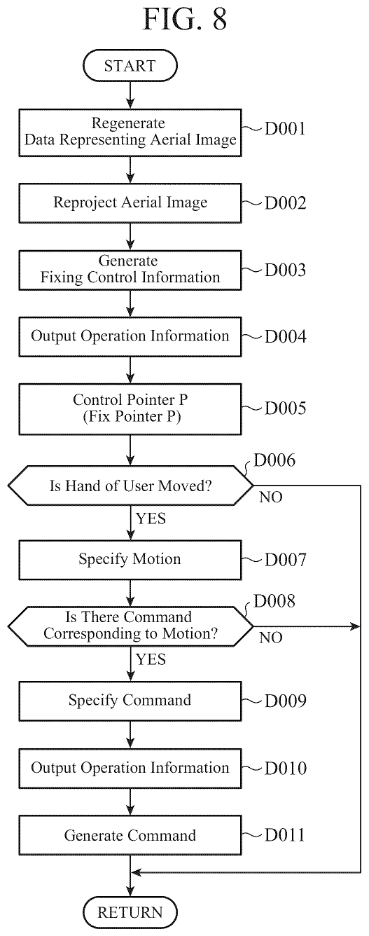

Next, the spatial processing B in step B008 will be described with reference to a flowchart illustrated in FIG. 8.

First, the aerial image generating unit 50 acquires the space determination result indicating that the hand of the user is located in the operation space B, which is output from the operation space determining unit 43, and regenerates data representing the aerial image S projected in a mode depending on the acquired space determination result (step D001). For example, the aerial image generating unit 50 regenerates data representing the aerial image S projected in red as the aerial image S indicating that the hand of the user is located in the operation space B. The aerial image generating unit 50 outputs data indicating the regenerated aerial image S to the aerial image projecting unit 31.

Next, the aerial image projecting unit 31 acquires data representing the aerial image S regenerated by the aerial image generating unit 50, and reprojects the aerial image S based on the acquired data onto the virtual space K (step D002). That is, the aerial image projecting unit 31 updates the aerial image S projected on the virtual space K. Thus, for example, the color of the aerial image S changes to red, and the user can easily grasp that the hand has entered the operation space B (that the command execution mode has been set). Note that steps D001 and D002 are not essential processes and may be omitted.

Next, the pointer operation information output unit 44 generates control information (fixing control information) indicating that the pointer P displayed on the operation screen R of the display 10 is fixed (step D003). In addition, the pointer operation information output unit 44 outputs operation information including the generated fixing control information to the pointer position control unit 45 (step D004).

Next, the pointer position control unit 45 fixes the pointer P on the operation screen R displayed on the display 10 on the basis of the fixing control information included in the operation information output from the pointer operation information output unit 44 (step D005).

Next, the command specifying unit 46 determines whether or not there has been a motion of the hand of the user on the basis of the position detection result output from the operation space determining unit 43 (step D006). As a result, when it is determined that there has been no motion of the hand of the user (step D006; NO), the processing returns. On the other hand, in a case where it is determined that there has been a motion of the hand of the user (step D006; YES), the processing proceeds to step D007.

In step D007, the command specifying unit 46 specifies the motion (gesture) of the hand of the user on the basis of the position detection result output from the operation space determining unit 43 (step D007).

Next, the command specifying unit 46 refers to the command information recorded in the command recording unit 47 and determines whether or not there is a motion corresponding to the specified motion of the hand in the command information (step D008). As a result, when it is determined that there is no motion corresponding to the specified motion of the hand in the command information (step D008; NO), the processing returns. On the other hand, in a case where it is determined that there is a motion corresponding to the specified motion of the hand in the command information (step D008; YES), the command specifying unit 46 specifies a command associated with the motion in the command information (step D009). The command specifying unit 46 outputs the specified command to the command output unit 48.

Next, the command output unit 48 outputs operation information including information indicating the command acquired from the command specifying unit 46 to the command generating unit 49 (step D010).

Next, the command generating unit 49 receives the operation information output from the command output unit 48 and generates a command included in the received operation information (step D011). Thus, in the interface system 100, a command corresponding to the motion (gesture) of the hand of the user is executed.

Note that, although not illustrated in the above flowchart, in step D009, the command specifying unit 46 may output the specified command to the aerial image generating unit 50. Then, the aerial image generating unit 50 may acquire the command output from the command specifying unit 46 and regenerate data representing the aerial image S projected in a mode according to the acquired command. Furthermore, the aerial image generating unit 50 may output data indicating the regenerated aerial image S to the aerial image projecting unit 31.

Further, the aerial image projecting unit 31 may acquire data representing the aerial image S regenerated by the aerial image generating unit 50 and reproject the aerial image S based on the acquired data on the virtual space K. That is, the aerial image projecting unit 31 may update the aerial image S projected on the virtual space K. Thus, for example, the aerial image S blinks once, and the user can easily grasp that the left click command has been executed.

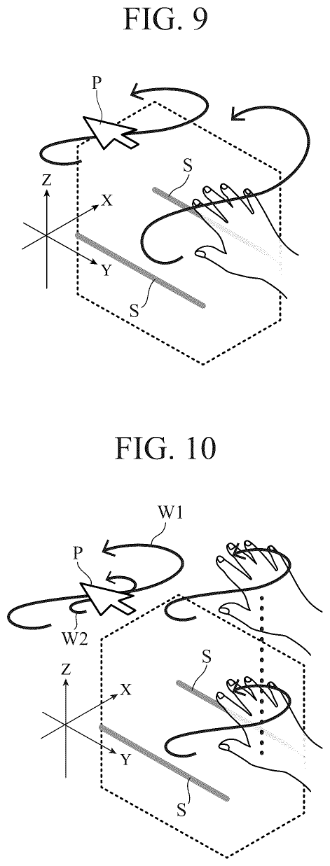

Next, a control example by the interface system 100 according to the first embodiment will be described with reference to FIGS. 9 to 17. The interface system 100 according to the first embodiment can perform, for example, the following control by operating as described above.

### (1) Pointer Movement

In a case where the hand of the user is located in the operation space A, the pointer P moves on the operation screen R of the display 10 depending on the motion amount of the hand of the user in the virtual space K (XYZ coordinate system) (see FIG. 9). Note that, although the pointer P is represented on the operation space A as a conceptual diagram in FIG. 9, the pointer P displayed on the operation screen R of the display 10 actually moves.

Note that, in the above case, the pointer operation information output unit 44 may generate the movement control information in which the moving amount or the moving speed of the pointer P changes depending on how far the three-dimensional position of the hand of the user is away from the boundary plane (XY plane) of the virtual space indicated by the aerial image S in the direction orthogonal to the boundary plane (that is, the Z-axis direction) even with the same motion amount of the hand of the user.

For example, as illustrated in FIG. 10, when the three-dimensional position of the hand of the user is far away from the boundary plane (XY plane) in the Z-axis direction, the pointer operation information output unit 44 may generate the movement control information indicating that the pointer P is moved by a distance equivalent to the distance in which the hand of the user has moved or at a speed equivalent to the speed at which the hand of the user has moved (reference numeral W1 in FIG. 10). On the other hand, the pointer operation information output unit 44 may generate the movement control information indicating that, even if the motion amount of the hand of the user is the same as described above, if the three-dimensional position of the hand of the user is close to the boundary plane (XY plane) in the Z-axis direction, the pointer P is moved by a distance of about half the distance in which the hand of the user has moved or at a speed of about half the speed at which the hand of the user has moved (reference numeral W2 in FIG. 10).

That is, the pointer operation information output unit 44 may generate the movement control information by multiplying a moving amount or a moving speed of the hand of the user projected on the boundary plane (XY plane) on which the aerial image S is projected by a coefficient corresponding to the distance in the Z-axis direction between the three-dimensional position of the hand of the user and the boundary plane (XY plane).

In this case, if the user moves the hand at a position far in the Z-axis direction from the boundary plane (XY plane) on which the aerial image S is projected, the user can move the pointer P by an amount corresponding to the motion amount of the hand or at the same speed as the motion of the hand. On the other hand, if the user moves the hand at a position close to the Z-axis direction from the boundary plane (XY plane) on which the aerial image S is projected, the user can finely (small) or slowly move the pointer P. In particular, when shifting from the pointer movement mode to the command execution mode, it is assumed that the user moves the hand near the boundary plane on which the aerial image S is projected. At that time, since the user can finely or slowly move the pointer P, the user can finely designate the position of the pointer P when executing the command, and convenience is improved.

Note that, here, the example has been described in which the pointer operation information output unit 44 generates the movement control information indicating that, when the three-dimensional position of the hand of the user is far away from the boundary plane (XY plane) in the Z-axis direction, the pointer P is moved by a distance equivalent to the distance in which the hand of the user has moved or at a speed equivalent to the speed at which the hand of the user has moved, and generates the movement control information indicating that, when the three-dimensional position of the hand of the user is close to the boundary plane (XY plane) in the Z-axis direction, the pointer P is moved by a distance of about half the distance in which the hand of the user has moved or at a speed of about half the speed at which the hand of the user has moved. However, contrary to the above, the pointer operation information output unit 44 may generate the movement control information indicating that, when the three-dimensional position of the hand of the user is far away from the boundary plane (XY plane) in the Z-axis direction, the pointer P is moved by a distance of about half the distance in which the hand of the user has moved or at a speed of about half the speed at which the hand of the user has moved, and may generate the movement control information indicating that, when the three-dimensional position of the hand of the user is close to the boundary plane (XY plane) in the Z-axis direction, the pointer P is moved by a distance equivalent to the distance in which the hand of the user has moved or at a speed equivalent to the speed at which the hand of the user has moved.

### (2) Pointer Fixation

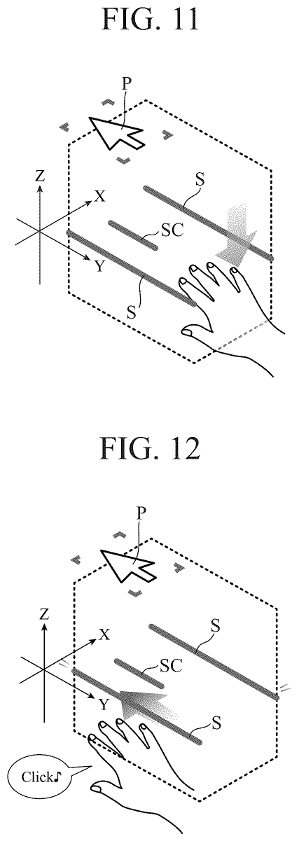

When the hand of the user enters the operation space B from the operation space A across the position (boundary position) of the aerial image, the pointer P is fixed on the operation screen R of the display 10 (see FIG. 11). Thereafter, even when the hand of the user moves in the operation space B, the pointer P remains fixed on the operation screen R of the display 10. Note that, at this time, the aerial image S is updated, and for example, the color of the aerial image S may be changed from blue to red. Thus, the user can easily grasp that the hand has entered the operation space B (has been changed to the command execution mode). Furthermore, at this time, the aerial image SC may be projected by the projecting device 20 at a position near the lower limit position of the detectable range by the detecting device 21 and near the substantially center of the virtual space K in the X-axis direction.

### (3) Left Click

For example, in the operation space B, when the user moves the hand in the −Y direction and the hand reaches a preset left click occurrence region, the motion (gesture) of the hand is specified by the command specifying unit 46. The left click occurrence region is, for example, a predetermined region on the left side (−X direction side) of the aerial image SC in the operation space B and on the far side (−Y direction side) as viewed from the user.

This motion (gesture) is associated with a command of “left click” in the command information. Therefore, the command specifying unit 46 specifies the command of “left click”, and the left click is executed (see FIG. 12). Furthermore, at this time, the aerial image generating unit 50 may regenerate data representing the aerial image S that blinks once, for example, and the aerial image projecting unit 31 may project the aerial image S based on the regenerated data. Thus, in the interface system 100, the aerial image S blinks once, and the user can easily grasp that the left click has been executed. Note that, at this time, the interface system 100 may output, for example, a “click” sound as a sound corresponding to the left click. Thus, the user can more easily grasp that the left click has been executed by hearing this sound.

### (4) Right Click

For example, in the operation space B, when the user moves the hand in the −Y direction and the hand reaches a preset right click occurrence region, the command specifying unit 46 specifies the motion (gesture) of the hand. The right click occurrence region is, for example, a predetermined region on the right side (+X direction side) of the aerial image SC in the operation space B and on the far side (−Y direction side) as viewed from the user.

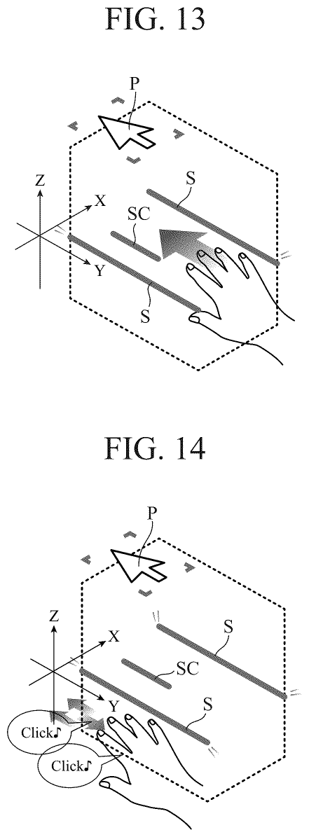

This motion (gesture) is associated with a command of “right click” in the command information. Therefore, the command specifying unit 46 specifies the command of “right click”, and the right click is executed (see FIG. 13). Furthermore, at this time, the aerial image generating unit 50 may regenerate data representing the aerial image S that blinks once, for example, and the aerial image projecting unit 31 may project the aerial image S based on the regenerated data. Thus, in the interface system 100, the aerial image S blinks once, and the user can easily grasp that the right click has been executed.

### (5) Left Double Click

For example, in the operation space B, in a state where the user moves the hand in the −Y direction and the hand reaches a preset left click occurrence region, when the user continuously moves the hand in the +Y direction and the −Y direction, the command specifying unit 46 specifies the motion (gesture) of the hand. This motion (gesture) is associated with the command “left double click” in the command information. Therefore, the command specifying unit 46 specifies the “left double click” command, and the left double click is executed (see FIG. 14). Furthermore, at this time, the aerial image generating unit 50 may regenerate data representing the aerial image S that blinks continuously twice, for example, and the aerial image projecting unit 31 may project the aerial image S based on the regenerated data. Thus, in the interface system 100, the aerial image S blinks continuously twice, and the user can easily grasp that the left double click has been executed. Note that, at this time, the interface system 100 may output continuous sounds such as “click” and “click” as sounds corresponding to the left double click. Thus, the user can more easily grasp that the left double click has been executed by hearing this sound.

### (6) Pointer Continuous Movement Operation

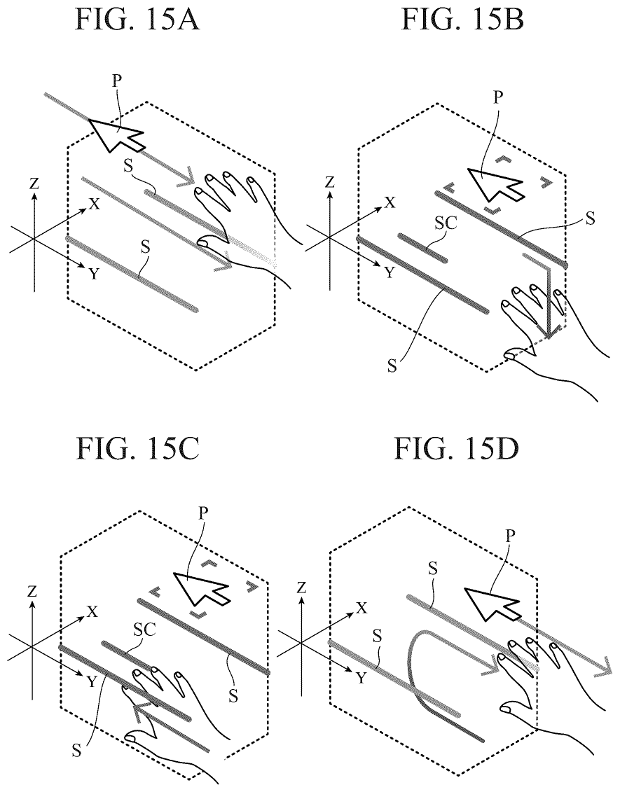

When the user moves the hand in the +Y direction in the operation space A, the pointer P also moves in the +Y direction in conjunction with the motion (see FIG. 15A). Here, the user once moves the hand to the operation space B to fix the pointer P (see FIG. 15B). In this state, when the user moves the hand in the −Y direction, the pointer P remains fixed (see FIG. 15C).

Then, when the user moves the hand from the operation space B to the operation space A across the boundary position (boundary plane), the pointer P moves again in conjunction with the motion of the hand of the user (see FIG. 15D). By repeating the above operation, the user can continuously move the pointer P only by moving the hand in the limited space of the operation space A and the operation space B.

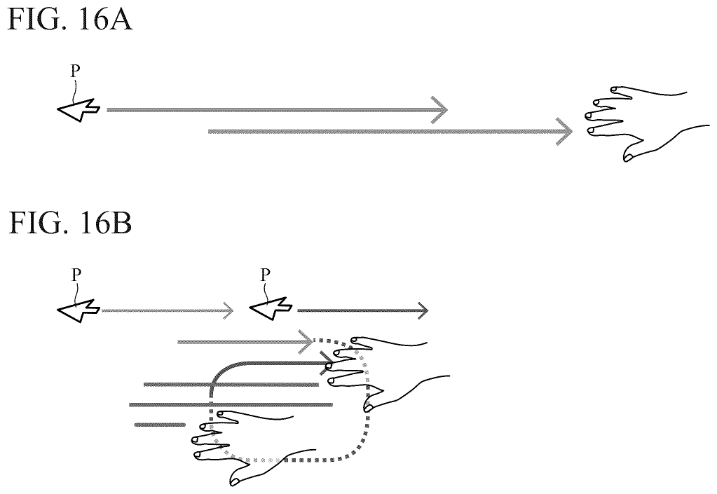

In this regard, in the above-described conventional device, for example, as illustrated in FIG. 16A, in an operation involving continuity such as long distance movement of the pointer P and scrolling, the moving amount of the hand of the user becomes large, and a wide space to such an extent that the large movement can be performed is required. On the other hand, in the first embodiment, for example, as illustrated in FIG. 16B, by the hand of the user moving back and forth at the boundary position (boundary plane), the correlation between the pointer P and the hand of the user can be reset. Therefore, the user can implement a continuous operation such as long distance movement of the pointer P and scrolling even in the limited space of the operation space A and the operation space B by repeating the motion of the hand with a short movement distance.

### (7) Scrolling Operation

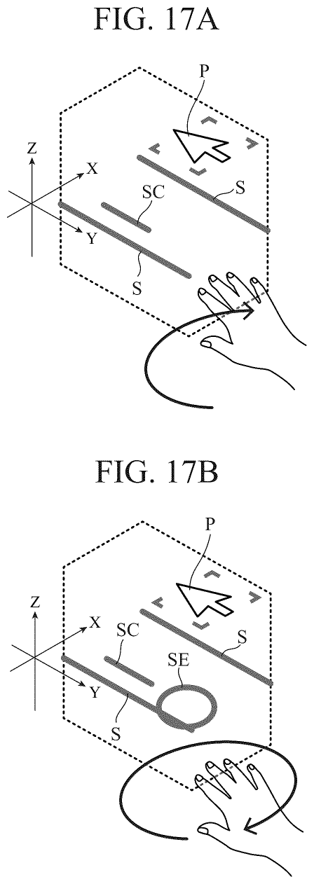

When the user starts a motion (gesture) such as turning a hand within a range not reaching the left click occurrence region or the right click occurrence region described above in the operation space B, the motion (gesture) of the hand is specified by the command specifying unit 46. This motion (gesture) is associated with the command “scroll operation” in the command information. Therefore, in the interface system 100, the command specifying unit 46 specifies the command of the “scroll operation”, and the scroll operation is executed (see FIG. 17A). Furthermore, at this time, the aerial image generating unit 50 may regenerate, for example, data representing the aerial image SE obtained by adding a predetermined figure to the current aerial image S, and the aerial image projecting unit 31 may project the aerial images S and SE based on the regenerated data (see FIG. 17B). Thus, the aerial images S and SE to which the predetermined graphic is added are projected, and the user can easily grasp that the scroll operation can be executed.

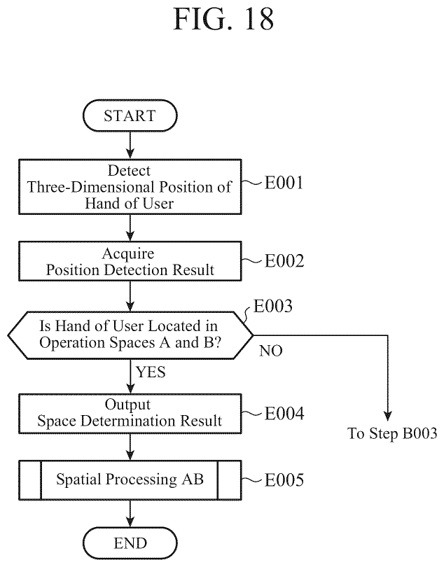

Next, an application operation example in the control execution phase of the interface system 100 according to the first embodiment will be described with reference to a flowchart illustrated in FIG. 18. In this applied operation example, an example in which the user operates both the operation space A and the operation space B using the left and right hands will be described.

First, when the user enters a hand into the virtual space K, the position detecting unit 32 detects the three-dimensional position of the hand of the user in the virtual space K (step E001). The position detecting unit 32 outputs a detection result (position detection result) of the three-dimensional position of the hand of the user to the position acquiring unit 41.

Next, the position acquiring unit 41 acquires the position detection result output from the position detecting unit 32 (step E002). The position acquiring unit 41 outputs the acquired position detection result to the operation space determining unit 43.

Next, the operation space determining unit 43 acquires the detection result output from the position acquiring unit 41, and determines the operation space in which the hand of the user is located on the basis of the acquired position detection result and the boundary position of each operation space in the virtual space K.

Next, the operation space determining unit 43 checks whether or not it is determined that the hand of the user is located in both the operation space A and the operation space B (step E003). When it is determined that the hand of the user is not located in both the operation space A and the operation space B (step E003; NO), the processing proceeds to step B003 of the flowchart of FIG. 6 described above.

On the other hand, when it is determined that the hand of the user is located in both the operation space A and the operation space B (step E003; YES), the operation space determining unit 43 outputs the determination result (space determination result) to the aerial image generating unit 50. In addition, the operation space determining unit 43 outputs the space determination result to the pointer operation information output unit 44 and the command specifying unit 46 together with the position detection result acquired from the position acquiring unit 41 (step E004). Thereafter, the processing proceeds to step E005 (spatial processing AB).

### <Spatial Processing AB>

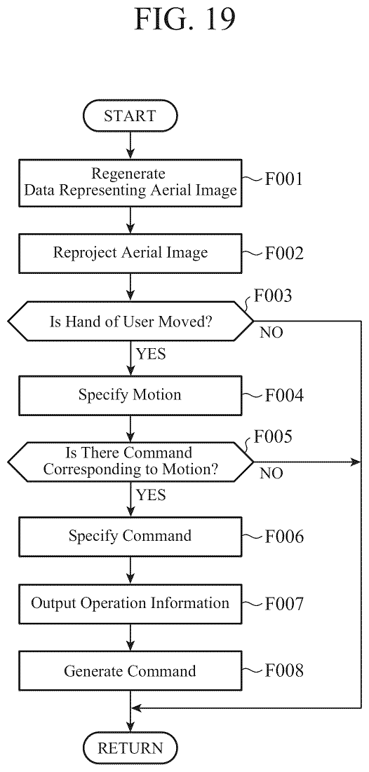

Next, spatial processing AB in step E005 will be described with reference to a flowchart illustrated in FIG. 19.

First, the aerial image generating unit 50 acquires the space determination result indicating that the hand of the user is located in both the operation space A and the operation space B, which is output from the operation space determining unit 43, and regenerates data representing the aerial image S projected in a mode depending on the acquired space determination result (step F001). For example, the aerial image generating unit 50 regenerates data representing the aerial image S projected in green as the aerial image S indicating that the hand of the user is located in both the operation space A and the operation space B. The aerial image generating unit 50 outputs data indicating the regenerated aerial image S to the aerial image projecting unit 31.

Next, the aerial image projecting unit 31 acquires data representing the aerial image S regenerated by the aerial image generating unit 50, and reprojects the aerial image S based on the acquired data onto the virtual space K (step F002). That is, the aerial image projecting unit 31 updates the aerial image S projected on the virtual space K. Thus, for example, the color of the aerial image S changes to green, and the user can easily grasp that the hand has entered both the operation space A and the operation space B. Note that step F001 and step F002 are not essential processes and may be omitted.

Next, the pointer operation information output unit 44 determines whether or not there has been a motion of the hand of the user on the basis of the position detection result output from the operation space determining unit 43 (step F003). As a result, when it is determined that there has been no motion of the hand of the user (step F003; NO), the processing returns. On the other hand, in a case where it is determined that there has been a motion of the hand of the user (step F003; YES), the processing proceeds to step F004.

In step F004, the command specifying unit 46 specifies the motion (gesture) of the hand of the user on the basis of the position detection result output from the operation space determining unit 43 (step F004). In this case, the motion (gesture) of the hand of the user is a motion obtained by combining the motion of the hand locating in the operation space A and the motion of the hand locating in the operation space B.

Next, the command specifying unit 46 refers to the command information recorded in the command recording unit 47 and determines whether or not there is a motion corresponding to the specified motion of the hand in the command information (step F005). As a result, when it is determined that there is no motion corresponding to the specified motion of the hand in the command information (step F005; NO), the processing returns.

On the other hand, in a case where it is determined that there is a motion corresponding to the specified motion of the hand in the command information (step F005; YES), the command specifying unit 46 specifies a command associated with the motion in the command information (step F006). The command specifying unit 46 outputs the specified command to the command output unit 48.

Next, the command output unit 48 outputs the operation information including the information indicating the command acquired from the command specifying unit 46 to the command generating unit 49 (step F007).

Next, the command generating unit 49 receives the operation information output from the command output unit 48 and generates a command included in the received operation information (step F008). Thus, in the interface system 100, a command corresponding to the motion (gesture) of the hand of the user is executed.

The interface system 100 according to the first embodiment can perform, for example, the following control by operating as described above.

### (8) Left Drag Operation

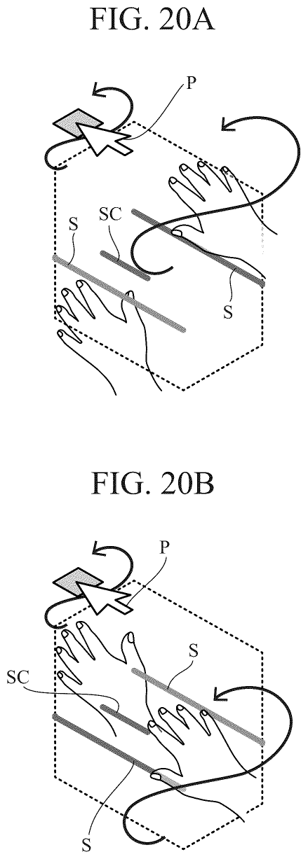

The user makes the left hand reach the left click occurrence region in the operation space B, and moves the right hand in the operation space A. Then, in the interface system 100, the command specifying unit 46 specifies the motions (gestures) of the left and right hands. This motion (gesture) is associated with a command of a “left drag operation” in the command information. Therefore, in the interface system 100, the command specifying unit 46 specifies the command of the “left drag operation”, and the left drag operation associated with the motion of the right hand of the user is executed (see FIG. 20A).

### (9) Right Drag Operation

The user makes the right hand reach the right click occurrence region in the operation space B, and moves the left hand in the operation space A. Then, in the interface system 100, the command specifying unit 46 specifies the motions (gestures) of the left and right hands. This motion (gesture) is associated with a command of a “right drag operation” in the command information. Therefore, in the interface system 100, the command specifying unit 46 specifies the command of the “right drag operation”, and the right drag operation associated with the motion of the left hand of the user is executed (see FIG. 20B).

Note that, in the above description, an example has been described in which the user performs the left drag operation and the right drag operation by moving the left and right hands, but these are merely examples, and the command executed by a combination of motions of the left and right hands of the user is not limited to the above example. As described above, by associating the combination of motions of the left and right hands of the user with the command, in the interface system 100, it is possible to increase the variations of the commands that can be executed by the user.

Furthermore, in the above description, the operation example in the spatial processing AB and the operation example in the above-described spatial processing B have been separately described for clarity of the description, but these processes may be continuously executed. For example, in the interface system 100, first, in the spatial processing B, the pointer position control unit 45 may fix the pointer P on the operation screen R on the basis of the fixing control information generated by the pointer operation information output unit 44, and then the spatial processing AB may be executed. That is, for example, the user may perform the left drag operation and the right drag operation described above by putting one of the left and right hands into the operation space B, fixing the pointer P on the operation screen R, and moving the left and right hands in the operation space A and the operation space B while maintaining the state. In this case, in the interface system 100, the spatial processing B and the spatial processing AB are continuously executed. Thus, in the interface system 100, it is possible to achieve both accurate pointing operation by the user and extension of variations of commands executable by the user.

As described above, in the interface system 100 according to the first embodiment, the aerial image S indicating the boundary position between the operation space A and the operation space B constituting the virtual space K is projected onto the virtual space K. Thus, the user can visually recognize the boundary position between the operation space A and the operation space B in the virtual space K, and can easily grasp at which position the operation space (mode) is switched.

In this regard, in the above-described conventional device, it is difficult for the user to visually recognize at which position in the virtual plane space the mode is switched, in other words, the boundary position (the boundary position between the first space and the second space, and the boundary position between the second space and the third space) of each space constituting the virtual plane space, and the user needs to grasp these positions while moving the hand to some extent. In addition, for this reason, the user cannot grasp the correlation between the pointer and the hand unless the user moves the hand to some extent, and it may take time to start the operation.

On the other hand, in the first embodiment, as described above, the user can visually recognize the boundary position between the operation space A and the operation space B in the virtual space K, and can easily grasp at which position the operation space (mode) is switched. In addition, this eliminates the need for the user to grasp the boundary position at which the operation space is switched by moving the hand, and the user can start the operation more quickly than the conventional device.

In addition, in a conventional non-contact pointing system including the conventional device, since it is difficult for the user to recognize the position in the virtual space corresponding to pressing of a button on an operation screen displayed on the display, it may be necessary to add an auxiliary display on the operation screen. Alternatively, in order to allow reliable pressing of the button on the operation screen in accordance with a touch operation in the virtual space, it may be necessary to make a change such as increasing the size of the button on the operation screen. That is, in the conventional non-contact pointing system, it may be necessary to rearrange existing software for displaying an operation screen.

Furthermore, in the conventional non-contact pointing system, even if the user stops his/her hand in the air and performs an operation (gesture) such as pushing, it may be difficult to designate an accurate position on the operation screen for the reason that the pointer position is shifted at the time of pushing. Furthermore, in the conventional non-contact pointing system, in an operation involving continuity such as long distance movement of a pointer and scrolling, the moving amount of the hand of the user increases, and a wide space may be required.

In this regard, in the first embodiment, as described above, the virtual space K is divided into the operation space A and the operation space B, and while the pointer P is made movable in conjunction with the motion of the hand of the user in the operation space A, the pointer P is fixed in the operation space B, and the motion (gesture) of the hand of the user that generates the command is recognized in a state where the pointer P is fixed. Thus, in the first embodiment, the position of the pointer P is prevented from shifting during the execution of the motion (gesture) of the hand that generates the command. Therefore, the user can not only perform an accurate pointing operation at the time of command execution, but also directly operate, for example, a small operation screen of a button created for mouse operation of the PC, and does not need to rearrange software for displaying the operation screen.

Further, in the first embodiment, since the user can operate the display device including the operation of the pointer P in a non-contact manner, the user can perform the operation in a non-contact manner even in a work environment in which hygiene is emphasized, for example, the hand of the user is dirty or the hand of the user is not desired to be dirty.

Further, in the first embodiment, the user can execute the command by the motion of the hand regardless of the shape of the finger, and thus the user does not need to memorize a specific finger gesture. Furthermore, in the first embodiment, since the detection target by the detecting device 21 is not limited to the hand of the user, if the detection target is an object other than the hand of the user, the user can perform an operation even when, for example, the user holds an object in the hand.

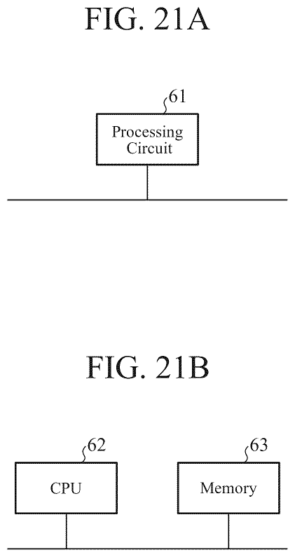

Finally, a hardware configuration of the device control device 12 included in the interface system 100 according to the first embodiment will be described with reference to FIG. 21. The functions of the position acquiring unit 41, the operation space determining unit 43, the pointer operation information output unit 44, the command specifying unit 46, the command output unit 48, and the aerial image generating unit 50 in the device control device 12 are implemented by a processing circuit. The processing circuit may be dedicated hardware as illustrated in FIG. 21A, or may be a central processing unit (CPU, which may also be referred to as a central processing device, a processing device, an arithmetic device, a microprocessor, a microcomputer, a processor, or a digital signa processor (DSP)) 62 that executes a program stored in a memory 63 as illustrated in FIG. 21B.

In a case where the processing circuit is dedicated hardware, the processing circuit 61 corresponds to, for example, a single circuit, a composite circuit, a programmed processor, a parallel programmed processor, an application specific integrated circuit (ASIC), a field-programmable gate array (FPGA), or a combination thereof. Each of the functions of the position acquiring unit 41, the operation space determining unit 43, the pointer operation information output unit 44, the command specifying unit 46, the command output unit 48, and the aerial image generating unit 50 may be implemented by the processing circuit 61, or the functions of the respective units may be collectively implemented by the processing circuit 61.

When the processing circuit is the CPU 62, the functions of the position acquiring unit 41, the operation space determining unit 43, the pointer operation information output unit 44, the command specifying unit 46, the command output unit 48, and the aerial image generating unit 50 are implemented by software, firmware, or a combination of software and firmware. The software and the firmware are described as programs and stored in the memory 63. The processing circuit implements the functions of the respective units by reading and executing the programs stored in the memory 63. That is, the device control device 12 includes a memory for storing a program that results in execution of each step illustrated in, for example, FIGS. 5 to 8 and FIGS. 18 to 19 when executed by the processing circuit. It can also be said that these programs cause a computer to execute procedures and methods performed in the position acquiring unit 41, the operation space determining unit 43, the pointer operation information output unit 44, the command specifying unit 46, the command output unit 48, and the aerial image generating unit 50. Here, the memory 63 corresponds to a nonvolatile or volatile semiconductor memory such as a random access memory (RAM), a read only memory (ROM), a flash memory, an erasable programmable ROM (EPROM), or an electrically-EPROM (EEPROM), a magnetic disk, a flexible disk, an optical disk, a compact disk, a mini disk, or a digital versatile disc (DVD).

Note that a part of the functions of the position acquiring unit 41, the operation space determining unit 43, the pointer operation information output unit 44, the command specifying unit 46, the command output unit 48, and the aerial image generating unit 50 may be implemented by dedicated hardware, and a part thereof may be implemented by software or firmware. For example, the function of the position acquiring unit 41 can be implemented by a processing circuit as dedicated hardware, and the functions of the operation space determining unit 43, the pointer operation information output unit 44, the command specifying unit 46, the command output unit 48, and the aerial image generating unit 50 can be implemented by the processing circuit reading and executing a program stored in the memory 63.

As described above, the processing circuit can implement the above-described functions by hardware, software, firmware, or a combination thereof.

As described above, according to the first embodiment, the interface system 100 includes the detecting unit 21 to detect a three-dimensional position of a detection target in the virtual space K divided into the plurality of operation spaces, the position acquiring unit 41 to acquire a three-dimensional position of the detection target detected by the detecting unit 21, the projecting unit 20 to project the aerial image S indicating a boundary position of each of the operation spaces in the virtual space K, the operation space determining unit 43 to determine an operation space including the three-dimensional position of the detection target on the basis of the three-dimensional position of the detection target acquired by the position acquiring unit 41 and the boundary position of each operation space in the virtual space K, and the operation information output unit 51 to output the operation information for executing a predetermined operation on the display device 1 by using at least a determination result by the operation space determining unit 43. Thus, in the interface system 100 according to the first embodiment, it is possible to visually recognize boundary positions of a plurality of operation spaces constituting the virtual space K to be operated by the user.

Further, the interface system 100 includes the aerial image generating unit 50 to generate data representing the aerial image S, and the projecting unit 20 projects the aerial image S based on the data generated by the aerial image generating unit 50. Thus, the interface system 100 according to the first embodiment can project the aerial image S generated on the basis of the data.

In addition, the aerial image generating unit 50 regenerates data representing the aerial image S projected in a projection mode depending on a determination result by the operation space determining unit 43, and the projecting unit 20 projects the aerial image S based on the data regenerated by the aerial image generating unit 50. Thus, the interface system 100 according to the first embodiment can project the aerial image S projected in the projection mode depending on the determination result by the operation space determining unit 43, and the user can easily grasp in which operation space the three-dimensional position of the detection target is included.

Further, the operation information output unit 51 includes the pointer operation information output unit 44 to generate information for moving the pointer P displayed on a screen of the display device 1 in accordance with a motion of the detection target in the first operation space when the operation space determining unit 43 determines that the operation space including the three-dimensional position of the detection target is the first operation space, and output the operation information including the generated information. Thus, in the interface system 100 according to the first embodiment, the user can move the pointer P in conjunction with the motion of the detection target in the first operation space.

In addition, the pointer operation information output unit 44 outputs information indicating that a moving amount or a moving speed of the pointer P displayed on the screen of the display device 1 is variable depending on a distance between a three-dimensional position of the detection target included in the first operation space and a boundary plane of the virtual space K represented by the aerial image S in a direction orthogonal to the boundary plane, by including the information in the operation information. Thus, the interface system 100 according to the first embodiment can vary the moving amount or the moving speed of the pointer P depending on the distance, and user convenience is improved.

In addition, the operation information output unit 51 includes a sound information output unit to generate information indicating to output a sound corresponding to a three-dimensional position of the detection target in the first operation space or a sound corresponding to the motion of the detection target in the first operation space, and output the information by including the information in the operation information. Thus, the interface system 100 according to the first embodiment can output a sound corresponding to the three-dimensional position of the detection target in the first operation space or the motion of the detection target, and the user can easily grasp the three-dimensional position or the motion of the detection target in the first operation space.

In addition, the pointer operation information output unit 44 generates, when the operation space determining unit 43 determines that the operation space including the three-dimensional position of the detection target is a second operation space, information indicating to fix the pointer P displayed on the screen of the display device 1, and outputs the generated information by including the information in the operation information. Thus, in the interface system 100 according to the first embodiment, even if the user moves the detection target in order to generate the command in the second operation space, the position of the pointer P remains fixed, so that an accurate pointing operation can be performed at the time of command execution. In addition, the existing operation screen can be operated as it is, and there is no need to rearrange software for displaying the operation screen.

In addition, the operation information output unit 51 includes the command specifying unit 46 to specify a motion of the detection target in a second operation space and specify a command corresponding to the specified motion of the detection target when the operation space determining unit 43 determines that the operation space including the three-dimensional position of the detection target is the second operation space, and the command output unit 48 to output the operation information including information indicating the command specified by the command specifying unit 46. Thus, in the interface system 100 according to the first embodiment, the user can execute a command corresponding to the motion of the detection target in the second operation space.

Furthermore, the aerial image generating unit 50 generates, when the operation space determining unit 43 determines that the operation space including the three-dimensional position of the detection target is the second operation space, data indicating a lower limit position of a detectable range by the detecting unit 21 and representing the aerial image SC that divides the second operation space into left and right spaces, and the projecting unit 20 projects the aerial image SC based on the data generated by the aerial image generating unit 50. Thus, in the interface system 100 according to the first embodiment, the user can easily grasp how much the hand may be lowered in the second operation space, and can execute a command that requires left and right designation.

In addition, the operation information output unit 51 includes a sound information output unit to generate information indicating to output a sound corresponding to fixation of the pointer P, and output the information by including the information in the operation information. Thus, the interface system 100 according to the first embodiment can output a sound corresponding to the fixation of the pointer P, and the user can easily grasp that the pointer P is fixed.

Further, the operation information output unit 51 includes the command specifying unit 46 to specify a motion of the detection target in a second operation space and specify a command corresponding to the specified motion of the detection target when the operation space determining unit 43 determines that the operation space including the three-dimensional position of the detection target is the second operation space, and the command output unit 48 to output information indicating the command specified by the command specifying unit 46 as the operation information, and after the pointer operation information output unit 44 outputs the operation information including the information to fix the pointer P displayed on the screen of the display device 1 and fixes the pointer, the detecting unit 21 detects a three-dimensional position of a first detection target and a three-dimensional position of a second detection target, and when the operation space determining unit 43 determines that an operation space including the three-dimensional position of the first detection target is the first operation space and an operation space including the three-dimensional position of the second detection target is the second operation space, the command specifying unit 46 specifies a motion of the first detection target in the first operation space and a motion of the second detection target in the second operation space, and specifies a command corresponding to a combination of two motions specified, and the command output unit 48 outputs the operation information including information indicating the command corresponding to the combination of the two motions specified by the command specifying unit 46. Thus, the interface system 100 according to the first embodiment can specify a command corresponding to a combination of two motions of the motion of the first detection target and the motion of the second detection target after fixing the pointer P, and can implement an accurate pointing operation by the user and increase variations of commands that can be executed by the user.

In addition, the operation information output unit 51 includes the command specifying unit 46 to specify a motion of the detection target in a second operation space and specify a command corresponding to the specified motion of the detection target when the operation space determining unit 43 determines that the operation space including the three-dimensional position of the detection target is the second operation space, and the command output unit 48 to output the operation information including information indicating the command specified by the command specifying unit 46. Thus, in the interface system 100 according to the first embodiment, the user can execute a command corresponding to the motion of the detection target in the second operation space.

Further, the aerial image generating unit 50 regenerates data representing the aerial image S to be projected in a projection mode according to the command specified by the command specifying unit 46, and the projecting unit 20 projects the aerial image S based on the data regenerated by the aerial image generating unit 50 when the command specified by the command specifying unit 46 is executed. Thus, the interface system 100 according to the first embodiment can project the aerial image S projected in the projection mode according to the command specified by the command specifying unit 46, and the user can easily grasp which command has been specified.

In addition, the operation information output unit 51 includes a sound information output unit to generate information indicating to output a sound corresponding to the command specified by the command specifying unit 46, and outputs the information by including the information in the operation information. Thus, the interface system 100 according to the first embodiment can output a sound corresponding to the command specified by the command specifying unit 46, and the user can easily grasp which command has been specified.

Furthermore, the detecting unit 21 detects a three-dimensional position of a first detection target and a three-dimensional position of a second detection target, and when the operation space determining unit 43 determines that an operation space including the three-dimensional position of the first detection target is the first operation space and an operation space including the three-dimensional position of the second detection target is the second operation space, the command specifying unit 46 specifies a motion of the first detection target in the first operation space and a motion of the second detection target in the second operation space, and specifies a command corresponding to a combination of two motions specified, and the command output unit 48 outputs the operation information including information indicating the command corresponding to the combination of the two motions specified by the command specifying unit 46. Thus, the interface system 100 according to the first embodiment can specify a command corresponding to a combination of two motions of the motion of the first detection target and the motion of the second detection target, and can increase variations of commands that can be executed by the user.

Furthermore, according to the first embodiment, the device control device 12 is a device control device 12 that controls the interface device 2 including the detecting unit 21 to detect a three-dimensional position of a detection target in a virtual space K divided into a plurality of operation spaces and the projecting unit 20 to project an aerial image S indicating a boundary position of each of the operation spaces in the virtual space K, the device control device including the position acquiring unit 41 to acquire a three-dimensional position of the detection target detected by the detecting unit 21, the operation space determining unit 43 to determine an operation space including the three-dimensional position of the detection target on the basis of the three-dimensional position of the detection target acquired by the position acquiring unit 41 and the boundary position of each of the operation spaces in the virtual space K, and the operation information output unit 51 that outputs operation information for executing a predetermined operation on the display device 1 using at least a determination result by the operation space determining unit 43. Thus, in the device control device 12 according to the first embodiment, it is possible to visually recognize boundary positions of the plurality of operation spaces constituting the virtual space K to be operated by the user.

Note that, in the present disclosure, any component of the embodiment can be modified, or any component in the embodiment can be omitted. For example, in the above description, the case where the aerial image S is configured by a line (straight line) shape has been described as an example, but the aerial image S is not limited thereto, and may be configured by any shape. In addition, the aerial image S is not limited to a figure, and may be configured by any character or character string. Furthermore, regarding the color of the aerial image S, the blinking mode (the number of times of blinking), and the sound output when a command is executed, the examples described above are merely examples, and colors, blinking modes, and sounds other than the above may be used. Furthermore, the control of the color of the aerial image S and the control of the blinking mode (the number of times of blinking) may be executed in units of pixels of the aerial image S. For example, the projecting device 20 may change the color or luminance of the entire aerial image S (all the pixels of the aerial image S) in the same manner, or may change the color or luminance of any part of the aerial image S (any part of the pixels of the aerial image S). Note that the projecting device 20 can increase variations of the projection mode of the aerial image S, for example, by adding any gradation to the aerial image S by changing the color or luminance of any part of the aerial image S.

### INDUSTRIAL APPLICABILITY

The present disclosure enables visual recognition of boundary positions of a plurality of operation spaces constituting a virtual space to be operated by a user, and is suitable for use in an interface system.

### REFERENCE SIGNS LIST

1: display device, 2: interface device, 10: display, 11: display control device, 12: device control device (control device), 20: projecting device (projecting unit), 21: detecting device (detecting unit), 31: aerial image projecting unit, 32: position detecting unit, 41: position acquiring unit (acquiring unit), 42: boundary position recording unit, 43: operation space determining unit (determining unit), 44: pointer operation information output unit, 45: pointer position control unit, 46: command specifying unit, 47: command recording unit, 48: command output unit, 49: command generating unit, 50: aerial image generating unit, 51: operation information output unit, 61: processing circuit, 62: CPU, 63: memory, 100: interface system, 201: light source, 202: beam splitter, 203: retroreflective material, A: operation space, B: operation space, K: virtual space, P: pointer, R: operation screen, S: aerial image, SC: aerial image, SE: aerial image

1. An interface system comprising processing circuitry
to perform detection of a three-dimensional position of a detection target in a virtual space divided into a plurality of operation spaces,
to acquire the three-dimensional position of the detection target detected by the detection,
to project an aerial image indicating a boundary position of each of the plurality of operation spaces in the virtual space,
to perform determination of an operation space including the three-dimensional position of the detection target on a basis of the three-dimensional position of the detection target and the boundary position of each of the plurality of operation spaces in the virtual space, and
to output operation information for executing a predetermined pointer movement operation or a predetermined command execution operation to a display information of a display device, by using at least a result of the determination,
wherein the predetermined pointer movement operation and the predetermined command execution operation which can be executed continuously are respectively associated with adjacent operation spaces among the plurality of operation spaces, and
the aerial image is projected to a closed plane dividing the adjacent operation spaces.

2. The interface system according to claim 1, wherein the processing circuitry is further configured
to generate data representing the aerial image, and
to project the aerial image based on the data generated.

3. The interface system according to claim 2, wherein the processing circuitry is further configured
to regenerate the data representing the aerial image to be projected in a projection mode depending on the result of the determination, and
to project the aerial image based on the data regenerated.

4. The interface system according to claim 2, wherein
the processing circuitry is further configured
to generate information for moving a pointer displayed on a screen of the display device corresponding to a motion of the detection target in a first operation space when the processing circuitry determines that the operation space including the three-dimensional position of the detection target is the first operation space, and output the operation information including the generated information.

5. The interface system comprising processing circuitry
to perform detection of a three-dimensional position of a detection target in a virtual space divided into a plurality of operation spaces,
to acquire the three-dimensional position of the detection target detected by the detection,
to project an aerial image indicating a boundary position of each of the plurality of operation spaces in the virtual space,
to perform determination of an operation space including the three-dimensional position of the detection target on a basis of the three-dimensional position of the detection target and the boundary position of each of the plurality of operation spaces in the virtual space,
to output operation information for executing a predetermined operation, the predetermined operation being performed on a display device, by using at least a result of the determination,
to generate data representing the aerial image,
to project the aerial image based on the data generated,
to generate information for moving a pointer displayed on a screen of the display device corresponding to a motion of the detection target in a first operation space when the processing circuitry determines that the operation space including the three-dimensional position of the detection target is the first operation space, and output the operation information including the generated information, and
to output information indicating that a moving amount or a moving speed of the pointer displayed on the screen of the display device is variable depending on a distance between the three-dimensional position of the detection target included in the first operation space and a boundary plane of the virtual space represented by the aerial image in a direction orthogonal to the boundary plane, by including the information in the operation information.

6. The interface system according to claim 4, wherein
the processing circuitry is further configured
to generate information indicating to output a sound corresponding to the three-dimensional position of the detection target in the first operation space or a sound corresponding to the motion of the detection target in the first operation space, and output the information by including the information in the operation information.

7. The interface system comprising processing circuitry
to perform detection of a three-dimensional position of a detection target in a virtual space divided into a plurality of operation spaces,
to acquire the three-dimensional position of the detection target detected by the detection,
to project an aerial image indicating a boundary position of each of the plurality of operation spaces in the virtual space,
to perform determination of an operation space including the three-dimensional position of the detection target on a basis of the three-dimensional position of the detection target and the boundary position of each of the plurality of operation spaces in the virtual space,
to output operation information for executing a predetermined operation, the predetermined operation being performed on a display device, by using at least a result of the determination,
to generate data representing the aerial image,
to project the aerial image based on the data generated,
to generate information for moving a pointer displayed on a screen of the display device corresponding to a motion of the detection target in a first operation space when the processing circuitry determines that the operation space including the three-dimensional position of the detection target is the first operation space, and output the operation information including the generated information, and
to generate, when the processing circuitry determines that the operation space including the three-dimensional position of the detection target is a second operation space, information indicating to fix the pointer displayed on the screen of the display device, and outputs the generated information by including the information in the operation information.

8. The interface system according to claim 7, wherein
the processing circuitry is further configured
to specify a motion of the detection target in a second operation space and specify a command corresponding to the specified motion of the detection target when the processing circuitry determines that the operation space including the three-dimensional position of the detection target is the second operation space; and
to output the operation information including information indicating the command specified.

9. The interface system according to claim 7, wherein
the processing circuitry is further configured
to generate, when the processing circuitry determines that the operation space including the three-dimensional position of the detection target is a second operation space, data indicating a lower limit position of a detectable range of the detection and representing an aerial image that divides the second operation space into left and right spaces, and
to project the aerial image based on the data generated.

10. The interface system according to claim 7, wherein
the processing circuit is further configured
to generate information indicating to output a sound corresponding to fixation of the pointer, and output the information by including the information in the operation information.

11. The interface system according to claim 7, wherein
the processing circuitry is further configured
to specify a motion of the detection target in a second operation space and specify a command corresponding to the specified motion of the detection target when the processing circuitry determines that the operation space including the three-dimensional position of the detection target is the second operation space; and
to output the operation information including information indicating the command specified, and
after the processing circuitry outputs the operation information including the information indicating to fix the pointer displayed on the screen of the display device and the pointer is fixed,
when the processing circuitry detects a three-dimensional position of a first detection target and a three-dimensional position of a second detection target, and
when the processing circuitry determines that an operation space including the three-dimensional position of the first detection target is the first operation space and an operation space including the three-dimensional position of the second detection target is the second operation space,
the processing circuitry specifies a motion of the first detection target in the first operation space and a motion of the second detection target in the second operation space, and specifies a command corresponding to a combination of the specified motion of the first detection target and the specified motion of the second detection target, and
the processing circuitry outputs the operation information including information indicating the command corresponding to the combination of the specified motion of the first detection target and the specified motion of the second detection target specified.

12. The interface system according to claim 4, wherein
the processing circuitry is further configured
to specify a motion of the detection target in a second operation space and specify a command corresponding to the specified motion of the detection target when the processing circuitry determines that the operation space including the three-dimensional position of the detection target is the second operation space; and
to output the operation information including information indicating the command specified.

13. The interface system comprising processing circuitry
to perform detection of a three-dimensional position of a detection target in a virtual space divided into a plurality of operation spaces,
to acquire the three-dimensional position of the detection target detected by the detection,
to project an aerial image indicating a boundary position of each of the plurality of operation spaces in the virtual space,
to perform determination of an operation space including the three-dimensional position of the detection target on a basis of the three-dimensional position of the detection target and the boundary position of each of the plurality of operation spaces in the virtual space,
to output operation information for executing a predetermined operation, the predetermined operation being performed on a display device, by using at least a result of the determination, and
to generate data representing the aerial image, wherein
the processing circuitry projects the aerial image based on the data generated, wherein
the processing circuitry is further configured
to generate information for moving a pointer displayed on a screen of the display device corresponding to a motion of the detection target in a first operation space when the processing circuitry determines that the operation space including the three-dimensional position of the detection target is the first operation space, and output the operation information including the generated information, wherein
the processing circuitry is further configured
to specify a motion of the detection target in a second operation space and specify a command corresponding to the specified motion of the detection target when the processing circuitry determines that the operation space including the three-dimensional position of the detection target is the second operation space; and
to output the operation information including information indicating the command specified, wherein
to regenerate data representing the aerial image projected in a projection mode according to the command specified, and
to project the aerial image based on the data regenerated when the command specified is executed.

14. The interface system according to claim 12, wherein
the processing circuitry is further configured
to generate information indicating to output a sound corresponding to the command specified, and output the information by including the information in the operation information.

15. The interface system comprising processing circuitry
to perform detection of a three-dimensional position of a detection target in a virtual space divided into a plurality of operation spaces,
to acquire the three-dimensional position of the detection target detected by the detection,
to project an aerial image indicating a boundary position of each of the plurality of operation spaces in the virtual space,
to perform determination of an operation space including the three-dimensional position of the detection target on a basis of the three-dimensional position of the detection target and the boundary position of each of the plurality of operation spaces in the virtual space,
to output operation information for executing a predetermined operation, the predetermined operation being performed on a display device, by using at least a result of the determination,
to generate data representing the aerial image,
to project the aerial image based on the data generated,
to generate information for moving a pointer displayed on a screen of the display device corresponding to a motion of the detection target in a first operation space when the processing circuitry determines that the operation space including the three-dimensional position of the detection target is the first operation space, and output the operation information including the generated information,
to specify a motion of the detection target in a second operation space and specify a command corresponding to the specified motion of the detection target when the processing circuitry determines that the operation space including the three-dimensional position of the detection target is the second operation space,
to output the operation information including information indicating the command specified, and
to detect a three-dimensional position of a first detection target and a three-dimensional position of a second detection target, and
when processing circuitry determines that an operation space including the three-dimensional position of the first detection target is the first operation space and an operation space including the three-dimensional position of the second detection target is the second operation space,
the processing circuitry specifies a motion of the first detection target in the first operation space and a motion of the second detection target in the second operation space, and specifies a command corresponding to a combination of the specified motion of the first detection target and the specified motion of the second detection target, and
the processing circuitry outputs the operation information including information indicating the command corresponding to the combination of the specified motion of the first detection target and the specified motion of the second detection target specified.

16. A control device that controls an interface device, the interface device comprising processing circuitry
to perform detection of a three-dimensional position of a detection target in a virtual space divided into a plurality of operation spaces; and
to project an aerial image indicating a boundary position of each of the plurality of operation spaces in the virtual space;
to acquire the three-dimensional position of the detection target detected by the detection,
to perform determination of an operation space including the three-dimensional position of the detection target on a basis of the three-dimensional position of the detection target and the boundary position of each of the plurality of operation spaces in the virtual space; and
to output operation information for executing a predetermined pointer movement operation or a predetermined command execution operation to a display information of a display device, by using at least a result of the determination
wherein the predetermined pointer movement operation and the predetermined command execution operation which can be executed continuously are respectively associated with adjacent operation spaces among the plurality of operation spaces, and
the aerial image is projected to a closed plane dividing the adjacent operation spaces.

17. An operation assistance method executed by an interface system, the method comprising:
projecting an aerial image indicating a boundary position of each of a plurality of operation spaces in a virtual space divided into the plurality of operation spaces;
performing detection of a three-dimensional position of a detection target in the virtual space;
acquiring the three-dimensional position of the detection target detected by the detection,
performing determination of an operation space including the three-dimensional position of the detection target on a basis of the three-dimensional position of the detection target and the boundary position of each of the plurality of operation spaces in the virtual space; and
outputting operation information for executing a predetermined pointer movement operation or a predetermined command execution operation to a display information of a display device, by using at least a result of the determination,
wherein the predetermined pointer movement operation and the predetermined command execution operation which can be executed continuously are respectively associated with adjacent operation spaces among the plurality of operation spaces, and
the aerial image is projected to a closed plane dividing the adjacent operation spaces.
